(19) United States
(12) Patent Application Publication
(10) Pub. No.: US 2007/0047390 A1
(43) Pub. Date: Mar. 1, 2007

(54) Timepiece with calendar mechanism indicating date by plurality of date indicators

(76) Inventor: Shigeo Suzuki, Chiba-shi (JP)

Correspondence Address: BRUCE L. ADAMS, ESQ., SUITE1231, 17 BATTERY PLACE, NEW YORK, NY, 10004, US

(21) Appl. No.: 11/509,530

(22) Filed: Aug. 24, 2006

(30) Foreign Application Priority Data
Aug. 29, 2005 (JP) 2005-248165

(51) Int. Cl. G04B 19/20

(52) U.S. Cl. 368/37

(57) ABSTRACT

To provide a timepiece with calendar mechanism compactly constituting a drive mechanism for driving a plurality of date indicators and including the date indicators having date characters which are large and easy to see. A timepiece with calendar mechanism of the invention includes a first date indicator and a second date indicator for indicating a position of 1 of a date, a third date indicator for indicating a position of 10 of the date and a program wheel & pinion capable of respectively rotating the first date indicator, the second date indicator, the third date indicator intermittently based on operation of a drive mechanism. The date can be indicated by one of first date characters of the first date indicator and one of third date characters of the third date indicator, and the date can be indicated by one of second date characters of the second date indicator and one of the third date characters of the third date indicator.

### BACKGROUND OF THE INVENTION

1. Field of the Invention

The present invention relates to a timepiece with a calendar mechanism indicating a date by a plurality of date indicators. Further in details, the invention relates to an analog timepiece with a calendar mechanism including a first date indicator and a second indicator for indicating a position of 1 of a date, and a third date indicator for indicating a position of 10 of a date.

2. Description of the Prior Art

(1) Description of Terms:

Generally, a machine body including a drive portion of a timepiece is referred to as “movement”. A state of constituting a finished product by attaching a dial and a hand to a movement and putting the movement in a timepiece case is referred to as “complete” of a timepiece. In both sides of a main plate constituting a base plate of a timepiece, a side of providing glass of a timepiece case, that is, a side of providing a dial is referred to as “back side” or “glass side” or “dial side” of a movement. In both sides of a main plate, a side of providing a case back of a timepiece case, that is, a side opposed to a dial is referred to as “top side” or “case back side” of movement. A train wheel integrated to “top side” of a movement is referred to as “top train wheel”. A train wheel integrated to “back side” of movement is referred to as “back train wheel”. Generally, “12 o'clock side” indicates a side of arranging a graduation in correspondence with 12 o'clock of a dial in an analog type timepiece. “12 o'clock direction” indicates a direction directed to “12 o'clock side” from a rotational center of an indicator in an analog type timepiece. Further, “3 o'clock side” indicates a side of arranging a graduation in correspondence with 3 o'clock of a dial in an analog type timepiece. “3 o'clock direction” indicates a direction directed to “3 o'clock side” from a rotational center of an indicator. Further, “6 o'clock side” indicates a side of arranging a graduation in correspondence with 6 o'clock of a dial in an analog type timepiece. “6 o'clock direction” indicates a direction directed to “6 o'clock side” from a rotational center of an indicator in an analog type timepiece. Further, “9 o'clock side” indicates a side of arranging a graduation in correspondence with 9 o'clock of a dial. “9 o'clock direction” indicates a direction directed to “9 o'clock side” from a rotational center of an indicator in an analog type timepiece. Further, there is a case of indicating a side of arranging other graduation of a dial as in “2 o'clock direction”, “2 o'clock side”.

(2) Timepiece with Calendar Mechanism of Background Art:

An explanation will be given of a timepiece with a calendar mechanism of a background art including a first date indicator indicating a position of 1 of a date, and a second date indicator indicating a position of 10 of a date as follows.

(2.1) Timepiece with Calendar Mechanism of First Type of Background Art:

In reference to FIG. 26, a timepiece with a calendar mechanism of a first type of a background art includes two date indicators 822, 824 overlapped each other at least partially. The first date indicator 822 provides date indication of a position of 1, and the second indicator 824 provides date indication of a position of 10. The first date indicator 822 is provided with numerals of “0”, “1” through “9”, that is, 10 pieces of numerals in a circumferential direction. The second date indicator 824 is provided with two sets of numerals from “0” through “3”, that is, 8 pieces of numerals in a circumferential direction. A drive mechanism includes a 24 hour indicator 820 rotating by one rotation per 24 hours by rotation of an hour wheel 816, an operating lever 844 operated by rotating the 24 hour indicator 820, and other wheel or the like for control. By operating the operating lever 844, a program wheel 850 is rotated, the first date indicator 822 is rotated by a first date indicator drive wheel 852, and the second date indicator 824 is rotated by a second date indicator drive wheel 854. Rotation of the first date indicator 822 is rectified by a first date indicator jumper 862. Rotation of the second date indicator 824 is rectified by a second date indicator jumper 864 (refer to, for example, European Patent Application Publication No. 1070996 A1).

(2.2) Timepiece with Calendar Mechanism of Second Type of Background Art:

In reference to FIG. 27, a timepiece with a calendar mechanism of a second type of a background art includes a 1 position circular disk 932 indicating a position of 1 of a date, and a 10 position circular disk 931 indicating a position of 10 of a date. A 1 position pinion 933 is fixed to the 1 position circular disk 932. A 1 position jumper 936 maintains an angular position of a 1 position pinion 933. A 10 position pinion 934 is fixed to the 10 position circular disk 931. A 10 position jumper 940 maintains an angular position of the 10 position pinion 934. The 1 position pinion 933 is brought in mesh with an upper half of a teeth row of a date gear 908. The 1 position circular disk 932 is provided with numerals of “0”, “1” through “9”, that is, 10 pieces of numerals in a circumferential direction. The 10 position circular disk 931 is provided with two sets of numerals from “0” through “3” and two of “0”, that is, 10 pieces of numerals in a circumferential direction. Respective hooks of a drive apparatus 906 are brought in mesh with a teeth row of the date gear 908, thereby, teeth of the date gear 908 are made to advance 1 pitch per 1 day. The 10 position pinion 934 is driven by 1 pitch by an intermediate movable part 937. The intermediate movable part 937 is driven by 1 pitch by the date gear 908 by way of an idle gear 938 (refer to, for example, JP-A-2000-147148).

According to a timepiece with a calendar mechanism of a first type of the background art, a drive mechanism for driving the first date indicator 822 and the second date indicator 824 includes the 24 hour indicator 820, the operating lever 844 and other wheel for control and therefore, there poses a problem that a structure of the drive mechanism is complicated and an area occupied by the drive mechanism is large. Further, according to the timepiece with the calendar mechanism of the second type of the background art, the 10 position pinion 934 is driven by the date gear 908 by way of the intermediate movable part 937 and the idle gear 938 and therefore, there poses a problem that a drive mechanism for driving the 10 position circular disk 931 is complicated and an area occupied by the drive mechanism is large. Further, a timepiece with a calendar mechanism of a background art poses a problem that a drive mechanism is complicated, and a rotational load of the drive mechanism is large. According to a timepiece with a calendar mechanism of a background art, 10 pieces of numerals indicating dates are provided in a circumferential direction of a date indicator and therefore, it is difficult to enlarge a size of numerals indicating the dates.

### SUMMARY OF THE INVENTION

It is an object of the invention to configure a timepiece with a calendar mechanism to include three date indicators comprising two date indicators for indicating a position of 1 of a date and one date indicator for indicating a position of 10 of a date and constitutes a drive mechanism for driving the three indicators by a compact mechanism having a simple structure. Further, it is other object of the invention to provide a timepiece with a calendar mechanism including a date indicator having a date character which is large and easy to be seen. Further, it is other object of the invention to provide a timepiece with a calendar mechanism in which a rotational load of a drive mechanism is small.

The invention is configured by a timepiece with calendar mechanism for indicating a date by a plurality of date indicators, the timepiece comprising a drive mechanism for driving the timepiece with calendar mechanism, a time indicator for indicating time information by being rotated by operating the drive mechanism, a first date indicator for indicating one portion of a position of 1 of the date, a second date indicator for indicating other portion of the position of 1 of the date, a third date indicator for indicating a position of 10 of the date, and a program wheel configured to be able to respectively rotate the first date indicator, the second date indicator, and the third date indicator intermittently based on an operation of the drive mechanism. The timepiece with calendar mechanism is configured such that information with regard to the date can be indicated by one of first date characters provided at the first date indicator and one of third characters provided at the third date indicator, outer peripheral portions of the first date indicator and the third date indicator being positioned to be proximate to each other, further, information with regard to the date can be indicated by one of second characters provided at the second date indicator and one of the third date characters provided at the third date indicator, outer peripheral portions of the second indicator and the third indicator being positioned to be proximate to each other. It is preferable to configure the timepiece with calendar mechanism such that a rotation center axis line of the first date indicator and a rotation center axis line of the second date indicator are configured to coincide with each other. By the configuration, the timepiece with calendar mechanism in which the drive mechanism for driving the first date indicator, the second date indicator, and the third date indicator is simply and compactly figured can be realized. Further, by the constitution, the timepiece with calendar mechanism including the date indicators having date characters which are large and easy to see can be realized.

It is preferable to configure the timepiece with calendar mechanism of the invention such that a rotation center axis line of the program wheel is configured to coincide with a rotation center axis line of the time indicator. Further, according to the timepiece with calendar mechanism of the invention, it is preferable that the program wheel includes a program date indicator configured to rotate based on the operation of the drive mechanism, a first program wheel configured to be able to rotate integrally with the program date indicator and to be able to intermittently rotate the first date indicator, a second program wheel configured to be able to rotate integrally with the program date indicator and to be able to intermittently rotate the second date indicator, and a third program wheel configured to be able to rotate integrally with the program date indicator and to be able to intermittently rotate the third date indicator. By the constitution, the timepiece with calendar mechanism configured compactly can be realized.

The timepiece with calendar mechanism of the invention can be configured such that the program date indicator includes 31 pieces of teeth portions for receiving the operation of the drive mechanism, the first program wheel includes 18 pieces of teeth portions for rotating the first date wheel, the second program wheel includes 18 pieces of teeth portions for rotating the second date indicator, the third program indicator includes 4 pieces of teeth portions for rotating the third date indicator, the first date indicator includes a first date character indicating face including 5 pieces of numerals aligned in a peripheral direction in an order of “0”, “1”, “2”, “3”, “4”, the second date indicator includes a second date character indicating face including 5 pieces of numerals aligned in a peripheral direction in an order of “5”, “6”, “7”, “8”, “9”, and the third date indicator includes a third date character indicating face including 4 pieces of numerals aligned in a peripheral direction in an order of “0”, “1”, “2”, “3” or 3 pieces of numerals aligned in the peripheral direction in an order of “1”, “2”, “3”. Different from a structure of the background art in which 10 pieces of numerals are provided in a circumferential direction, according to the constitution of the invention, a size of the numeral indicating the date of the date indicator can be made to be larger than that of the background art. Therefore, by the invention, the timepiece with calendar mechanism in which calendar indication is large and easy to see can be realized.

According to the timepiece with calendar mechanism of the invention, it is preferable to further comprise an intermediate date driving wheel configured to rotate based on the operation of the drive mechanism and arranged to overlap the program wheel, a date driving wheel configured to rotate based on rotation of the intermediate date driving wheel, and a date driving finger configured to rotate based on rotation of the date driving wheel, wherein the program date wheel is configured to rotate based on rotation of the date driving finger. By the constitution, the timepiece with calendar mechanism configured compactly can be realized.

According to the timepiece with calendar mechanism of the invention, it is preferable to further comprise a program date indicator jumper for rectifying rotation of the program date indicator, a first date indicator jumper for rectifying rotation of the first date indicator, a second date indicator jumper for rectifying rotation of the second date indicator, and a third date indicator jumper for rectifying rotation of the third date indicator. By the constitution, rotation of the program date wheel, the first date indicator, the second date indicator, and the third date indicator can be rectified simultaneously and firmly.

The timepiece with calendar mechanism of the invention can be configured to further comprise a calendar correcting mechanism capable of correcting a display content of the first date indicator, a display content of the second date indicator, a display content of the third date indicator by rotating a hand setting stem in a state of pulling the hand setting stem to a hand setting stem position capable of correcting a calendar, wherein the calendar correcting mechanism includes a calendar correcting wheel, and is configured to be able to rotate the program wheel by rotating the calendar correcting wheel based on rotation of the hand setting stem in a state of pulling the hand setting stem to the hand setting stem position capable of correcting the calendar. According to the timepiece with calendar mechanism of the invention, a train wheel constituting the calendar mechanism can be configured compactly and by a small number of parts and therefore, a rotational load of the drive mechanism can be reduced.

### BRIEF DESCRIPTION OF THE SEVERAL VIEWS OF THE DRAWINGS

A preferred form of the present invention is illustrated in the accompanying drawings in which:

FIG. 1 is an outline plane view showing a relationship of arrangements of three date indicators and a program wheel when a movement is viewed from a dial side according to a first embodiment of a timepiece with calendar mechanism of the invention;

FIG. 2 is an outline plane view showing a structure when the movement in a state of removing a second main plate from the dial side according to the first embodiment of the timepiece calendar mechanism of the invention;

FIG. 3 is a partial sectional view showing portions of a first date indicator, a second date indicator, and a program wheel according to the first embodiment of the timepiece with calendar mechanism of the invention;

FIG. 4 is a partial sectional view showing portions of the program wheel, a date driving wheel & pinion according to the first embodiment of the timepiece with calendar mechanism of the invention;

FIG. 5 is an outline plane view showing a structure when a movement is viewed from a case back side according to the first embodiment of the timepiece with calendar mechanism of the invention;

FIG. 6 is an outline plane view showing a structure when the movement in a state of removing a balance bridge, a train wheel bridge, and an automatic winding train wheel bridge is viewed from the case back side according to the first embodiment of the timepiece with calendar mechanism of the invention;

FIG. 7A is a plane view showing the first date indicator according to the first embodiment of the timepiece with calendar mechanism of the invention, FIG. 7B is a plane view showing the second date indicator;

FIG. 8 is a plane view showing a third date indicator according to the first embodiment of the timepiece with calendar mechanism of the invention;

FIG. 9 is a plane view showing a third program wheel according to the first embodiment of the timepiece with calendar mechanism of the invention;

FIG. 10 is a plane view showing a first program wheel according to the first embodiment of the timepiece with calendar mechanism of the invention;

FIG. 11 is a plane view showing a second program wheel according to the first embodiment of the timepiece with calendar mechanism of the invention;

FIG. 12 is a block diagram showing a drive mechanism, a top train wheel, a calendar mechanism and the like according to the first embodiment of the timepiece with calendar mechanism of the invention;

FIG. 13 illustrates partial plane views showing a state of indicating “29 day” according to the first embodiment of the timepiece with calendar mechanism of the invention, FIG. 13A is an enlarged partial plane view showing portions of the first date indicator and the first program wheel, FIG. 13B is an enlarged partial plane view showing portions of the second date indicator and the second program wheel, FIG. 13C is an enlarged partial plane view showing portions of the first date indicator, the second date indicator, the first program wheel, and the second program wheel, FIG. 13D is an enlarged partial plane view showing portions of the third indicator and the third program wheel;

FIG. 14 illustrates partial plane views showing a state of indicating “30 day” according to the first embodiment of the timepiece with calendar mechanism of the invention, FIG. 14A is an enlarged partial plane view showing portions of the first date indicator and the first program wheel, FIG. 14B is an enlarged partial plane view showing portions of the second date indicator and the second program wheel, FIG. 14C is an enlarged partial plane view showing portions of the first date indicator, the second date indicator, the first program wheel, and the second program wheel, FIG. 14D is an enlarged partial plane view showing portions of the third indicator and the third program wheel;

FIG. 15 illustrates partial plane views showing a state of indicating “31 day” according to the first embodiment of the timepiece with calendar mechanism of the invention, FIG. 15A is an enlarged partial plane view showing portions of the first date indicator and the first program wheel, FIG. 15B is an enlarged partial plane view showing portions of the second date indicator and the second program wheel, FIG. 15C is an enlarged partial plane view showing portions of the first date indicator, the second date indicator, the first program wheel, and the second program wheel, FIG. 15D is an enlarged partial plane view showing portions of the third indicator and the third program wheel;

FIG. 16 illustrates partial plane views showing a state of indicating “1 day” according to the first embodiment of the timepiece with calendar mechanism of the invention, FIG. 16A is an enlarged partial plane view showing portions of the first date indicator and the first program wheel, FIG. 16B is an enlarged partial plane view showing portions of the second date indicator and the second program wheel, FIG. 16C is an enlarged partial plane view showing portions of the first date indicator, the second date indicator, the first program wheel, and the second program wheel, FIG. 16D is an enlarged partial plane view showing portions of the third indicator and the third program wheel;

FIG. 17 illustrates partial plane views showing a state of indicating “4 day” according to the first embodiment of the timepiece with calendar mechanism of the invention, FIG. 17A is an enlarged partial plane view showing portions of the first date indicator and the first program wheel, FIG. 17B is an enlarged partial plane view showing portions of the second date indicator and the second program wheel, FIG. 17C is an enlarged partial plane view showing portions of the first date indicator, the second date indicator, the first program wheel, and the second program wheel, FIG. 17D is an enlarged partial plane view showing portions of the third indicator and the third program wheel;

FIG. 18 illustrates partial plane views showing a state of indicating “5 day” according to the first embodiment of the timepiece with calendar mechanism of the invention, FIG. 18A is an enlarged partial plane view showing portions of the first date indicator and the first program wheel, FIG. 18B is an enlarged partial plane view showing portions of the second date indicator and the second program wheel, FIG. 18C is an enlarged partial plane view showing portions of the first date indicator, the second date indicator, the first program wheel, and the second program wheel, FIG. 18D is an enlarged partial plane view showing portions of the third indicator and the third program wheel;

FIG. 19 illustrates partial plane views showing a state of indicating “6 day” according to the first embodiment of the timepiece with calendar mechanism of the invention, FIG. 19A is an enlarged partial plane view showing portions of the first date indicator and the first program wheel, FIG. 19B is an enlarged partial plane view showing portions of the second date indicator and the second program wheel, FIG. 19C is an enlarged partial plane view showing portions of the first date indicator, the second date indicator, the first program wheel, and the second program wheel, FIG. 19D is an enlarged partial plane view showing portions of the third indicator and the third program wheel;

FIG. 20 illustrates partial plane views showing a state of indicating “9 day” according to the first embodiment of the timepiece with calendar mechanism of the invention, FIG. 20A is an enlarged partial plane view showing portions of the first date indicator and the first program wheel, FIG. 20B is an enlarged partial plane view showing portions of the second date indicator and the second program wheel, FIG. 20C is an enlarged partial plane view showing portions of the first date indicator, the second date indicator, the first program wheel, and the second program wheel, FIG. 20D is an enlarged partial plane view showing portions of the third indicator and the third program wheel;

FIG. 21 illustrates partial plane views showing a state of indicating “10 day” according to the first embodiment of the timepiece with calendar mechanism of the invention, FIG. 21A is an enlarged partial plane view showing portions of the first date indicator and the first program wheel, FIG. 21B is an enlarged partial plane view showing portions of the second date indicator and the second program wheel, FIG. 21C is an enlarged partial plane view showing portions of the first date indicator, the second date indicator, the first program wheel, and the second program wheel, FIG. 21D is an enlarged partial plane view showing portions of the third indicator and the third program wheel;

FIG. 22 illustrates partial plane views showing a state of indicating “11 day” according to the first embodiment of the timepiece with calendar mechanism of the invention, FIG. 22A is an enlarged partial plane view showing portions of the first date indicator and the first program wheel, FIG. 22B is an enlarged partial plane view showing portions of the second date indicator and the second program wheel, FIG. 22C is an enlarged partial plane view showing portions of the first date indicator, the second date indicator, the first program wheel, and the second program wheel, FIG. 22D is an enlarged partial plane view showing portions of the third indicator and the third program wheel;

FIG. 23 is a plane view showing a complete in a state of indicating “30 day” in a constitution of arranging a date window in 12 o'clock direction of a dial according to the first embodiment of the timepiece with calendar mechanism of the invention;

FIG. 24 is an outline plane view showing a structure when a movement is viewed from a case back side according to a second embodiment of a timepiece with calendar mechanism of the invention;

FIG. 25 is a partial sectional view showing a drive mechanism, a top train wheel, a calendar mechanism and the like according to the second embodiment of the timepiece with calendar mechanism of the invention;

FIG. 26 is a block diagram showing a structure of a calendar mechanism according to a timepiece with calendar mechanism of a first type of a background art; and

FIG. 27 is a block diagram showing a structure of a calendar mechanism according to a timepiece with calendar mechanism of a second type of a background art.

### DETAILED DESCRIPTION OF THE PREFERRED EMBODIMENTS

An embodiment of a timepiece with a calendar mechanism according to the invention will be explained in reference to the drawings as follows.

(1) Structure of First Embodiment of Timepiece with Calendar Mechanism According to the Invention:

First, a first embodiment of a timepiece with calendar mechanism according to the invention will be explained. The first embodiment of the timepiece with calendar mechanism according to the invention is an embodiment constituting the timepiece with calendar mechanism by a mechanical type timepiece with automatic winding mechanism.

(1.1) Structure of Top Side of Movement:

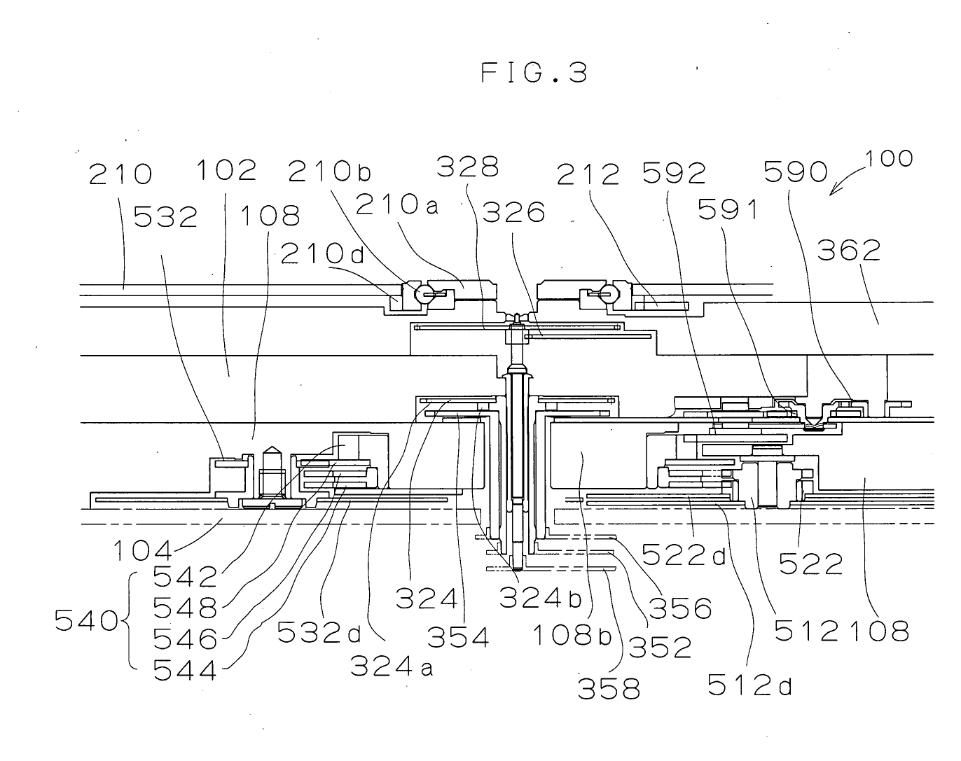

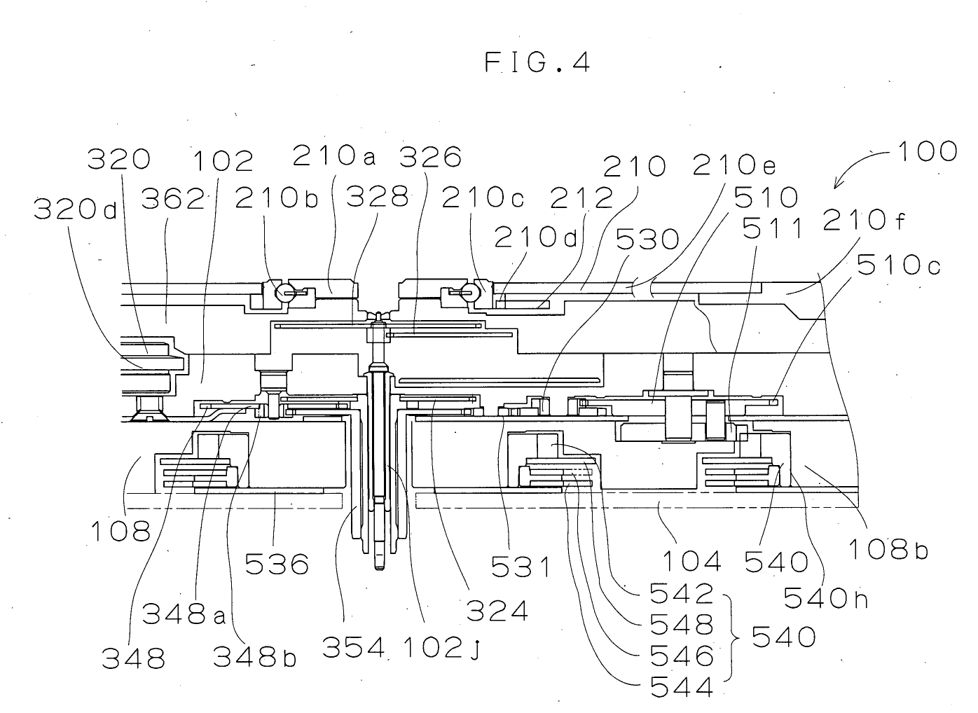

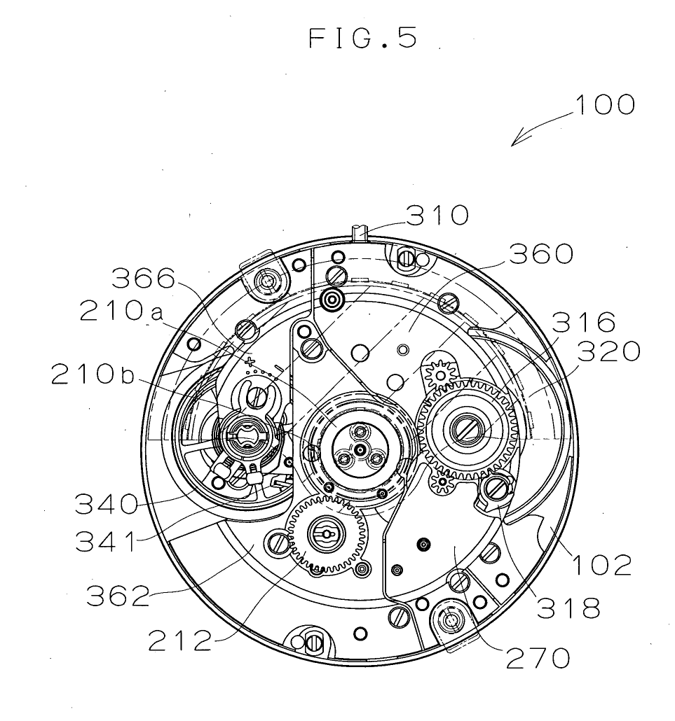

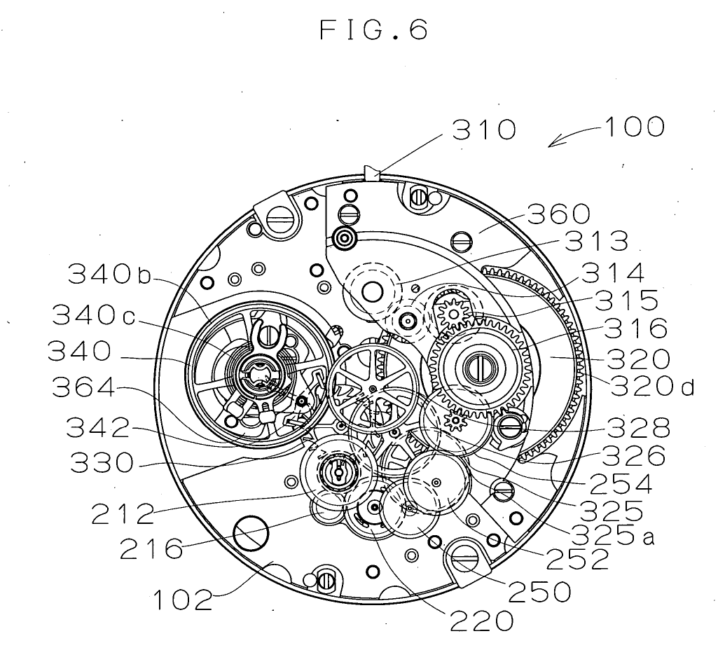

An outline structure of a top side (side of main plate opposed to dial) of a movement will be explained. In reference to FIG. 3 through FIG. 6, in a timepiece with calendar mechanism according to the invention, a movement 100 includes a main plate 102 constituting a base plate of the movement 100. A hand setting stem 310 is rotatably integrated to a hand setting stem guide hole of the main plate 102. A dial 104 (shown in FIG. 3, FIG. 4 by imaginary line) is attached to the movement 100. In reference to FIG. 5 and FIG. 6, an escapement/speed control apparatus including a balance with hairspring 340, and an escape wheel & pinion 330 and a pallet fork 342, and the top train wheel including a fourth wheel & pinion 328, a third wheel & pinion 326, a second wheel & pinion 325 and a barrel complete 320 are arranged on “top side” of the movement 100. A switching apparatus including a setting lever, a yoke, a yoke spring, a yoke holder are arranged on “back side” of the movement 100. Further, a barrel bridge 360 for rotatably supporting an upper shaft portion of the barrel complete 320 and an upper shaft portion of the second wheel & pinion 325, a train wheel bridge 362 for rotatably supporting an upper shaft portion of the third wheel & pinion 326, upper shaft portion of the fourth wheel & pinion 328 and an upper shaft portion of the escape wheel & pinion 330, a pallet bridge 364 for rotatably supporting an upper shaft portion of the pallet fork 342, and a balance bridge 366 for rotatably supporting an upper shaft portion of the balance with hairspring 340 are arranged on “top side” of the movement 100.

(1.2) Automatic Winding Mechanism:

Next, a structure of an automatic winding mechanism will be explained. In reference to FIG. 3 through FIG. 6, an automatic winding mechanism includes an oscillating weight 210, a first transmission wheel & pinion 212 rotated based on rotation of the oscillating weight 210, a second transmission wheel & pinion 216 rotated based on rotation of the first transmission wheel & pinion 212, a switch transmission wheel & pinion 220 rotated in one direction based on rotation of the first transmission wheel & pinion 212 and the second transmission wheel & pinion 216, a first reduction wheel & pinion 250 rotated based on rotation of the switch transmission wheel & pinion 220, a second reduction wheel & pinion 252 rotated based on rotation of the first reduction wheel & pinion 250, and a third reduction wheel & pinion 254 rotated based on rotation of the second reduction wheel & pinion 252. The oscillating weight 210 includes an inner ring 210a fixed to the train wheel bridge 362, a plurality of balls 212b, an outer ring 210c, an oscillating weight pinion 210d integrally provided with the outer ring 210c, an oscillating weight member 210e fixed to the outer ring 210c, and an oscillating weight portion 210f fixed to the oscillating weight member 210e. The outer ring 210c is configured to be rotatable relative to the inner ring 210a by way of the ball 210b. The first transmission wheel & pinion 212 includes a first transmission wheel and a first transmission pinion. The first transmission wheel & pinion 212 is provided rotatably to a first transmission wheel pin provided at the main plate 102. The oscillating weight pinion 210d is configured to be brought in mesh with the first transmission wheel. The second transmission wheel & pinion 216 includes a second transmission wheel. The second transmission wheel is configured to be brought in mesh with a first transmission pinion. An upper shaft portion of the second transmission wheel & pinion 216 and an upper shaft portion of the switch transmission wheel & pinion 220 are rotatably provided to the train wheel bridge 362. A lower shaft portion of the second transmission wheel & pinion 216, a lower shaft portion of the switch transmission wheel & pinion 220 are rotatably provided at the main plate 102.

The first reduction wheel & pinion 250 includes a first reduction wheel and a first reduction pinion. The second reduction wheel & pinion 252 includes a second reduction wheel. The first reduction pinion is configured to be brought in mesh with the second reduction wheel. The third reduction wheel & pinion 254 includes a third reduction wheel and a third reduction pinion. The second reduction wheel is configured to be brought in mesh with the first reduction pinion and the third reduction wheel. An upper shaft portion of, the first reduction wheel & pinion 250, an upper shaft portion of the second reduction wheel & pinion 252 are rotatably provided at an automatic train wheel bridge (reduction bridge) 270. A lower shaft portion of the first reduction wheel & pinion 250, a lower shaft portion of the second reduction wheel & pinion 252 are rotatably provided at the barrel bridge 360. The third reduction wheel & pinion 254 is rotatably provided at a third reduction wheel & pinion pin provided to the barrel bridge 360. The third reduction pinion is configured to be brought in mesh with a ratchet wheel 316. The switch transmission wheel & pinion 220 includes a switch transmission pinion. According to the automatic winding mechanism, regardless of a direction of rotating the oscillating weight 210, a rotational direction of the switch transmission pinion is constant and therefore, based on rotation of the switch transmission pinion, the ratchet wheel 316 can be rotated only in one direction by way of rotation of the first reduction wheel & pinion 250, the second reduction wheel & pinion 252, the third reduction wheel & pinion 254. By rotating the ratchet wheel 316, a main spring at inside of the barrel complete 320 can be wound up only in one direction.

(1.3) Escapement/Speed Control Apparatus and Top Train Wheel:

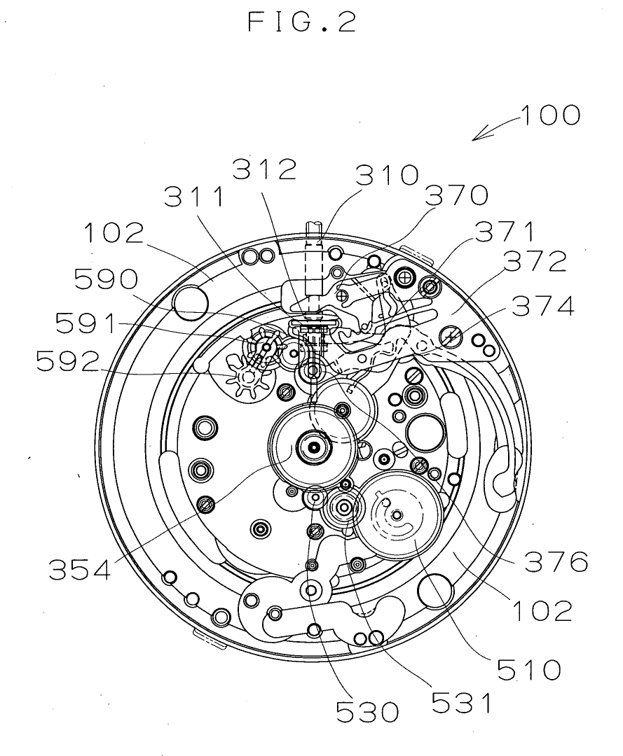

Next, a structure of the escapement/speed control apparatus and the top train wheel will be explained. A position in an axis line direction of the hand setting stem 310 is determined by a switching apparatus, mentioned later. When the hand setting stem 310 is rotated in a state in which the hand setting stem 310 is disposed at a first hand setting stem position (0 stage) on a side the most proximate to an inner side of the movement 100 along a rotation axis line direction, a winding pinion 312 is rotated by way of rotation of a clutch wheel 311 (refer to FIG. 2). A crown wheel 313 is configured to rotate by rotation of the winding pinion 312. A crown transmission wheel 314 is configured to be rotated by rotation of the crown wheel 313. A pivoting crown wheel 315 is configured to be rotated by rotation of the crown transmission wheel 314. The ratchet wheel 316 is rotated by rotation of the pivoting crown wheel 315. The barrel complete 320 includes a barrel wheel 320d, a barrel stem, and the main spring. The main spring contained in the barrel complete 320 is configured to be wound up by rotating the ratchet wheel 316.

The second wheel & pinion 325 is configured to be rotated by rotation of the barrel complete 320. The second wheel & pinion 325 includes a second wheel 325a and a second pinion. The barrel wheel 320d is configured to be brought in mesh with the second pinion. The third wheel & pinion 326 is configured to be rotated by rotation of the second wheel & pinion 325. The third wheel & pinion 326 includes a third wheel and a third pinion. The fourth wheel & pinion 328 is configured to rotate by one rotation per 1 minute by rotation of the third wheel & pinion 326. The fourth wheel & pinion 328 includes a fourth wheel and a fourth pinion. The third wheel is configured to be brought in mesh with the fourth pinion. The escape wheel & pinion 330 is configured to be rotated by rotation of the fourth wheel & pinion 328 while being controlled by the pallet fork 342. The escape wheel & pinion 330 includes an escape wheel and an escape pinion. The fourth wheel is configured to be brought in mesh with the escape pinion. The barrel complete 320, the second wheel & pinion 325, the third wheel & pinion 326, the fourth wheel & pinion 328 configure the top train wheel. The escapement/speed control apparatus for controlling rotation of the top train wheel includes the balance with hairspring 340, the escape wheel & pinion 330, the pallet fork 342. That is, the escape wheel & pinion 330, the pallet fork 342, the balance with hairspring 340 configure the escapement/speed control apparatus. The balance with hairspring 340 includes a balance stem, a balance wheel 340b, and a hairspring 340c. The hairspring 340c is a thin plate spring of a mode in a spiral shape (helical shape) having a plurality of turn numbers. The balance with hairspring 340 is rotatably supported by the main plate 102 and the balance bridge 366.

The barrel complete 320, the second wheel & pinion 325 are rotatably supported by the main plate 102 and the barrel bridge 360. That is, an upper shaft portion of the barrel complete 320 is rotatably supported by the barrel bridge 360, and an upper shaft portion of the second wheel & pinion 325, an upper shaft portion of the escape wheel & pinion 330 are rotatably supported by the train wheel bridge 362. Further, a lower shaft portion of the barrel complete 320, a lower shaft portion of the second wheel & pinion 325 are rotatably supported by the main plate 102. The third wheel & pinion 326, the fourth wheel & pinion 328, the escape wheel & pinion 330 are rotatably supported by the main plate 102 and the train wheel bridge 362. That is, an upper shaft portion of the third wheel & pinion 326, an upper shaft portion of the fourth wheel & pinion 328, and an upper shaft portion of the escape wheel & pinion 330 are rotatably supported by the train wheel bridge 362. A lower shaft portion of the third wheel & pinion 326, and a lower shaft portion of the escape wheel & pinion 330 are rotatably supported by the main plate 102. A lower shaft portion of the fourth wheel & pinion 328 is rotatably supported at inside of a center hole of a center pipe 102j fixed to the main plate 102. The pallet fork 342 is rotatably supported by the main plate 102 and the pallet bridge 364. An upper shaft portion of the pallet fork 342 is rotatably supported by the pallet bridge 364. A lower shaft portion of the pallet fork 342 is rotatably supported by the main plate 102. By rotation of the second wheel & pinion 325, the fourth wheel & pinion 328 is rotated by one rotation per 1 minute by way of rotation of the third wheel & pinion 326. A second hand 358 attached to the fourth wheel & pinion 328 indicates “second” by way of rotation of the third wheel & pinion 326.

(1.4) Switching Mechanism, Back Train Wheel, Hand Setting Mechanism:

Constitutions of a switching mechanism, a hand setting mechanism will be explained as follows. In reference to FIG. 2 and FIG. 3, a switching apparatus including a setting lever 370, a yoke 371, and a yoke holder 372 are arranged on “back side” of the movement 100. The switching apparatus can also be arranged on “top side” of the movement 100. The clutch wheel 311 is arranged to include a rotational axis line the same as the rotational axis line of the hand setting stem 310. When the hand setting stem 310 is disposed at 0 stage, 1 stage, and 2 stage, the clutch wheel 311 is configured to rotate based on rotation of the hand setting stem 310. A setting wheel 376 is arranged rotatably relative to a setting wheel rotating lever 374.

In reference to FIG. 2 through FIG. 4, a second main plate 108 is arranged on a side of the dial 104 of the main plate 102. A minute driving wheel & pinion 324 includes a minute driving wheel 324a and a cannon pinion 324b. The minute driving wheel 324a is configured to be brought in mesh with the third pinion. The minute wheel 342a and the cannon pinion 324b are configured to rotate integrally. The minute driving wheel 324a is arranged between the main plate 102 and the second main plate 108. The cannon pinion 324b and the minute driving wheel 324a are provided with a slip mechanism configured to enable the cannon pinion 324b to slip relative to the minute driving wheel 324a. A minute wheel & pinion 348 is configured to rotate by rotation of the third wheel & pinion 326 by way of rotation of the minute driving wheel & pinion 324. The minute wheel & pinion 348 includes a minute wheel 348a, a minute pinion 348b. The minute wheel & pinion 348 is arranged between the main plate 102 and the second main plate 108. The cannon pinion 324b is configured to be brought in mesh with the minute wheel 348a. An hour wheel 354 is configured to be brought in mesh with the minute pinion 348b. A wheel portion of the hour wheel 354 is arranged between the main plate 102 and the second main plate 108.

The hour wheel 354 is configured to be rotated by one rotation per 12 hours by way of rotation of the minute wheel & pinion 348. The minute driving wheel & pinion 324, the minute wheel & pinion 348, the hour wheel 354 configure the back train wheel. The minute driving wheel & pinion 324 is rotated by one rotation per 1 hour by rotation of the barrel complete 320 by way of rotation of the second wheel & pinion 325, and the third wheel & pinion 326. A minute hand 352 attached to the cannon pinion 324b of the minute driving wheel & pinion 324 indicates “minute”. Based on rotation of the minute driving wheel & pinion 324, the hour wheel 354 is rotated by one rotation per 12 hours by way of rotation of the hour wheel & pinion 348. An hour hand 356 attached to the hour wheel 354 indicates “hour”. When the hand setting stem 310 is pulled to 2 stage, the setting wheel rotating lever 374 is rotated, when the hand setting stem 310 is rotated in a state of being disposed at a third hand setting stem position (2 stage), the minute wheel & pinion 348 can be rotated by way of rotation of the clutch wheel 311, the setting wheel 376. In a state in which the hand setting stem 310 is disposed at 2 stage, when the minute wheel & pinion 348 is rotated, the cannon pinion 324b and the hour wheel 354 can be rotated and therefore, time of the timepiece can be corrected. Under the state, the cannon pinion 324b can be slipped relative to the minute driving wheel 324a by the slipping mechanism provided at the cannon pinion 324b and the minute driving wheel 324a.

(1.5) Constitution of Date Indicator Driving Mechanism:

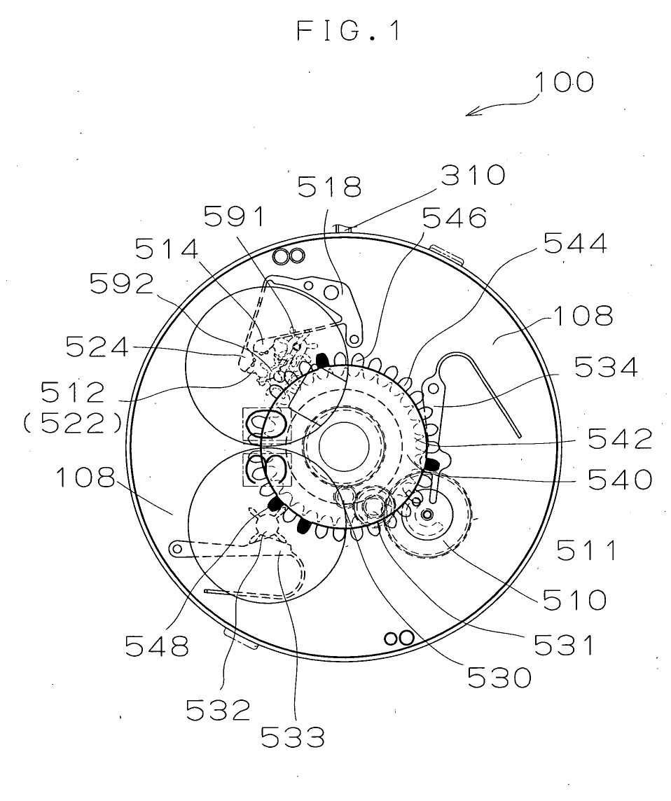

A constitution of a date indicator driving mechanism will be explained as follows. In reference to FIG. 1 through FIG. 4, a date indicator driving mechanism includes an intermediate first date driving wheel & pinion 530, an intermediate second date driving wheel & pinion 531, a date driving wheel & pinion 510, a date driving finger 511, a program wheel & pinion 540, a program date wheel jumper 534. The intermediate first date driving intermediate wheel & pinion 530 is rotatably integrated to an intermediate first date driving wheel pin provided at the main plate 102. The intermediate second date driving wheel & pinion 531 is rotatably integrated to an intermediate second date driving wheel pin provided at the main plate 102. The date driving wheel 510 and the date driving finger 511 are rotatably integrated to a pin provided at the main plate 102. A wheel portion of the hour wheel 534 is brought in mesh with a wheel portion of the intermediate wheel first date driving wheel & pinion 530. The wheel portion of the intermediate first date driving wheel & pinion 530 is brought in mesh with a wheel portion of the intermediate second date driving wheel & pinion 531. A pinion portion of the intermediate second date driving wheel & pinion 531 is brought in mesh with a wheel portion of a date driving wheel 510c. By rotating the hour wheel 354, the date driving wheel & pinion 510 is configured to rotate by one rotation per 24 hours by way of rotation of the intermediate first date driving wheel & pinion 530, the intermediate second date driving wheel & pinion 531. A date driving finger 511 is configured to rotate based on rotation of the date driving wheel 510. The intermediate first date driving wheel & pinion 530 and the intermediate second date driving wheel & pinion 531 are arranged between the main plate 102 and the second main plate 108. The date driving wheel & pinion 510 is arranged between the main plate 102 and the second main plate 108. It is preferable to arrange a rotational center of the date driving wheel & pinion 510 between “7 o'clock direction” and “8 o'clock direction” of the dial.

In reference to FIG. 1 through FIG. 4 and FIG. 9, a center hole 540h of the program wheel & pinion 540 is rotatably integrated to an outer periphery of a program wheel guide shaft portion 108b provided at the second main plate 108. A program wheel holder 536 is arranged on a side of the dial 104 of the second main plate 108. The program wheel & pinion 540 is arranged between the second main plate 108 and the program wheel holder 536. In a state in which the hour wheel 354, and the minute driving wheel & pinion 324 constituting time indicator are rotatable, rotation center axis lines of the hour wheel 354, and the minute driving wheel & pinion 324 constituting the time indicating wheels are configured to be disposed on an inner side of the center hole 540h of the program wheel & pinion 540. It is preferable to configure the rotation center axis lines of the hour wheel 354, and the minute driving wheel & pinion 324 constituting the time indicating wheels to coincide with a rotation center axis line of the program wheel & pinion 540. By the constitution, in the timepiece with calendar mechanism, an area occupied by a driving mechanism for driving a first date indicator 512, a second date indicator 522, a third date indicator 532 can be reduced.

In reference to FIG. 1 through FIG. 4 and FIG. 9 through FIG. 11, the program wheel & pinion 540 includes a program date indicator 542 configured to rotate by rotation of the date driving finger 511, a first program wheel 544 configured to be able to rotate integrally with the program date indicator 542 and to be able to rotate the first date indicator 512 intermittently, a second program wheel 546 configured to be able to rotate integrally with the program date wheel 542 and to be able to rotate the second date indicator 522 intermittently, and a third program wheel 548 configured to be able to rotate integrally with the program date indicator 542 and to be able to rotate a third date indicator 532 intermittently. The program date wheel 542, the first program wheel 544, the second program wheel 546, and the third program wheel 548 can be configured by a laminated structure such that respective center axis lines thereof are disposed at the same position.

The program date indicator 542 is arranged on a side the most proximate to the main plate 102. The third program wheel 548 is arranged on a side proximate to the main plate 102 next to the program date wheel 542. The first program wheel 544 is arranged to a side the most proximate to the dial 104. The second program wheel 546 is arranged to a side proximate to the dial 104 next to the first program wheel 544. That is, the program date indicator 542, the third program wheel 548, the second program wheel 546, the first program wheel 544 are arranged by a laminated structure in this order from the side the most proximate to the main plate 102 to the dial 104. Or, an order of laminating the program date indicator 542, the third program wheel 548, the second program wheel 546, the first program wheel 544 may be altered from the above-described order.

In the program wheel & pinion 540 illustrated in FIG. 1, portions in a trapezoidal shape coated in black indicate portions at which teeth portions are present at both of the second program wheel 546 and the third program wheel 548 and portions in the trapezoidal shape which are not coated in black indicate portions at which teeth portions are present at the first program wheel 544 and/or the second program wheel 546.

In reference to FIG. 1 and FIG. 3, the first date indicator 512 is rotatably integrated to the second main plate 108. The first date indicator jumper 514 is integrated to the second main plate 108. The first date indicator jumper 514 for rectifying a position in a rotational direction of the first date indicator 512 includes a spring portion and a rectifying portion provided at a front end of the spring portion. The rectifying portion of the first date indicator jumper 514 is configured to rectify two pieces of teeth portions 516 of the first date indicator 512.

The second date indicator 522 is rotatably integrated to the first date indicator 512. A second date indicator jumper 524 for rectifying a position in a rotational direction of the second date indicator 522 is integrated to the second main plate 108. The second date indicator jumper 524 includes a spring portion and a rectifying portion provided at a front end of the spring portion. The rectifying portion of the second indicator jumper 524 is configured to rectify two pieces of teeth portions 526 of the second date indicator 522. The first date indicator jumper 514 and the second date indicator jumper 524 can be configured as portions of a first and second date indicator jumper 518. Or, the first date indicator jumper 514 and the second date indicator jumper 524 may be configured as separate parts.

A third date indicator 532 is rotatably integrated to the second main plate 108. A third date indicator jumper 533 for rectifying a position in a rotational direction of the third date indicator 532 is integrated to the second main plate 108. The third date indicator jumper 533 includes a spring portion and a rectifying portion provided at a front end of the spring portion. The rectifying portion of the third date indicator jumper 533 is configured to rectify two pieces of teeth portions 535 of the third date indicator 532.

In reference to FIG. 1, it is preferable to arrange a rotational center of the first date indicator 512 and a rotational center of the second date indicator 522 between “1 o'clock direction” and “2 o'clock direction” of the dial. It is preferable to arrange the rotational center of the first date indicator 512 and the rotational center of the second date indicator 522 at the same position. It is preferable that a straight line connecting the rotational center of the first date indicator 512 and a rotational center of the third date indicator 532 becomes in parallel with a center axis line of the hand setting stem 310. By the constitution, a timepiece with calendar mechanism in which a calendar indication is large and easy to see can be realized.

It is preferable to position an outer peripheral portion of the first date indicator 512 and an outer peripheral portion of the second date indicator 522 to be proximate to an outer peripheral portion of the third date indicator 532. Outer peripheries of the first date indicator 512 and the third date indicator 532 are positioned to be proximate to each other, and information with regard to date is configured to be able to be indicated by one of first date characters provided at the first date indicator 512 and one of third date characters provided at the third date indicator 532. Further, the outer peripheral portions of the second date indicator 522 and the third date indicator 532 are positioned to be proximate to each other, and information with regard to date can be indicated by one of the first date characters provided at the first date indicator 512 and the third date characters provided at the third date indicator 532.

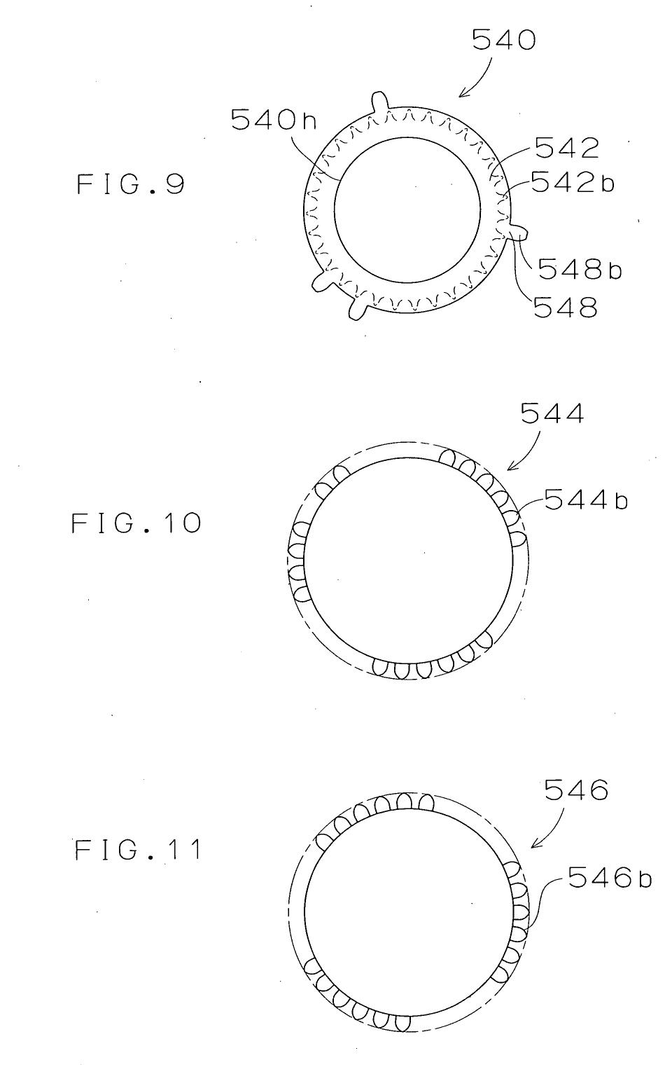

In reference to FIG. 9, the program date wheel 542 includes 31 pieces of program date indicator teeth portions 542b formed to configure equal angular intervals. The angular interval of the program date indicator teeth portions 542b is 360/31 degrees. Rotational center axis lines of the hour wheel 354 and the minute driving wheel & pinion 324 constituting the time indicating wheels are configured to coincide with the rotational center axis line of the program wheel & pinion 540. When configured in this way, the program date indicator 542 is disposed at the center of the movement 100, an outer diameter dimension of the program date indicator 542 can be increased and therefore, a calendar correcting mechanism can be arranged freely to some degrees. According to the constitution, a module of a wheel constituting the calendar correcting mechanism can be increased. Therefore, according to the timepiece with calendar mechanism of the invention, a degree of freedom of design of the calendar correcting mechanism is large.

In reference to FIG. 10, the first program wheel 544 includes 18 pieces of first program wheel teeth portions 544b formed by the equal shape. Angular intervals of the first program wheel teeth portions 544b are 360/31 degrees, 360/31 degrees, 360/31 degrees, 360/31 degrees, 360/31 degrees, 5*360/31 degrees, 360/31 degrees, 360/31 degrees, 360/31 degrees, 360/31 degrees, 360/31 degrees, 5*360/31 degrees, 360/31 degrees, 360/31 degrees, 360/31 degrees, 2*360/31 degrees, 360/31 degrees, 5*360/31 degrees.

In reference to FIG. 11, the second program wheel 546 includes 18 pieces of second program wheel teeth portions 546b formed by an equal shape. Angular intervals of the second program wheel teeth portions 546b are 360/31 degrees, 360/31 degrees, 360/31 degrees, 360/31 degrees, 360/31 degrees, 5*360/31 degrees, 360/31 degrees, 360/31 degrees, 360/31 degrees, 360/31 degrees, 360/31 degrees, 5*360/31 degrees, 360/31 degrees, 360/31 degrees, 360/31 degrees, 360/31 degrees, 360/31 degrees, 360/31 degrees, 5*360/31 degrees.

In reference to FIG. 9, the third program wheel 548 includes 4 pieces of third program wheel teeth portions 548b formed by an equal shape. Angular intervals of the third program wheel teeth portions 548b are 10*360/31 degrees, 9*360/31 degrees, 2*360/31 degrees, 10*360/31 degrees.

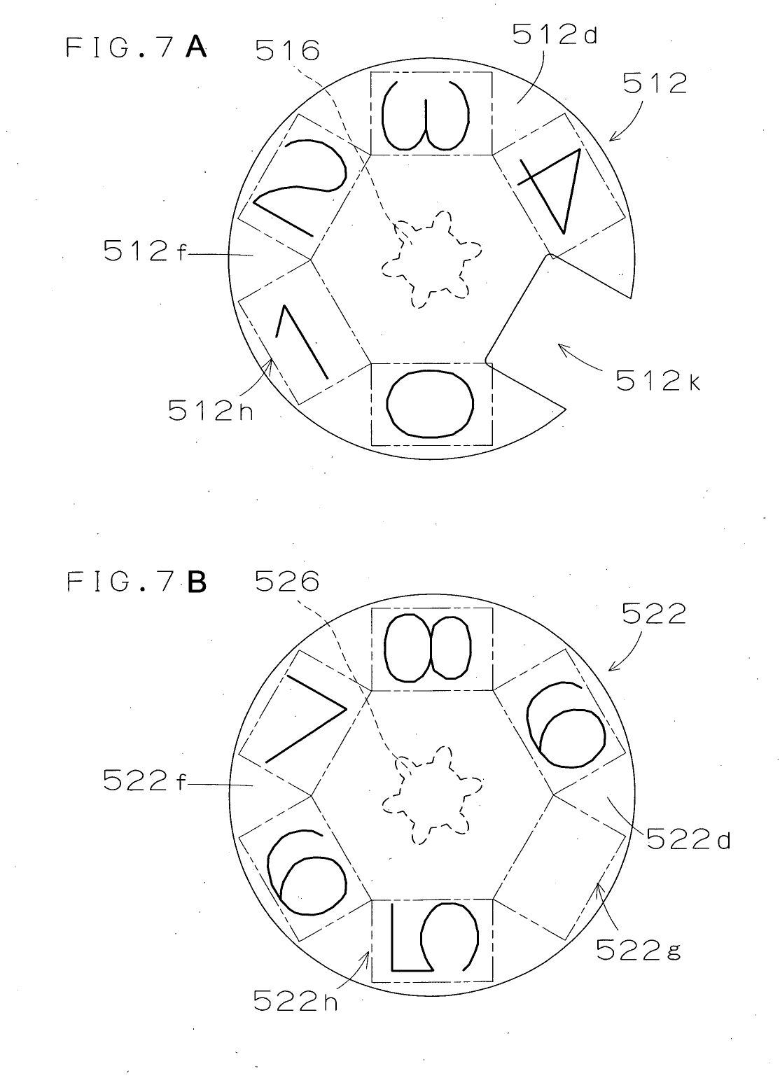

In reference to FIG. 7A, the first date indicator 512 includes a first date plate 512d and 6 pieces of first date indicator teeth portions 516 formed to configure equal angular intervals. A first date character indicating face 512f is provided at an upper face of the first date plate 512d. First date characters 512h comprising 5 pieces of numerals are provided at the first date character indicating face 512f. The first date characters 512h include numerals in a circumferential direction in an order of “0”, “1”, “2”, “3”, “4”. That is, the first date characters 512h are provided for indicating portions of a position of 1 of a date, that is, “0”, “1”, “2”, “3”, and “4”. 5 pieces of numerals constituting the first date characters 512h are arranged at the first date character indicating face 512f at equal angular intervals, that is, intervals of (360/6) degrees. A notch portion 512k is provided between “0” of the first date character 512h and “4” of the first date character 512h. The notch portion 512k is formed in an angular range of (360/6) degrees to correspond to a range for providing one character of the first date character 512h.

In reference to FIG. 7B, the second date indicator 522 includes a second date plate 522d and 6 pieces of second date indicator teeth portions 526 formed to configure equal intervals. A second date character indicating face 522f is provided at an upper face of a second date plate 522d. Second date characters 522h comprising 5 pieces of numerals and one piece of “solid portion” 522g are provided at the second date character indicating face 522f. The second date characters 522h are arranged in a circumferential direction in an order of “5”, “6”, “7”, “8”, and “9”. That is, the second date characters 522h are provided to indicate other portions of the position of 1 of the date, that is, “5”, “6”, “7”, “8”, and “9”. The “solid portion” 522g is arranged between “5” of the second date character 522h and “9” of the second date character 522h. 5 pieces of numerals constituting the second date characters 522h are arranged at the second character indicating face 522f at equal intervals, that is, at intervals of (360/6) degrees. The “solid portion” 522g is formed in an angular range of (360/6) degrees to correspond to a range of providing one character of the second date character 522h.

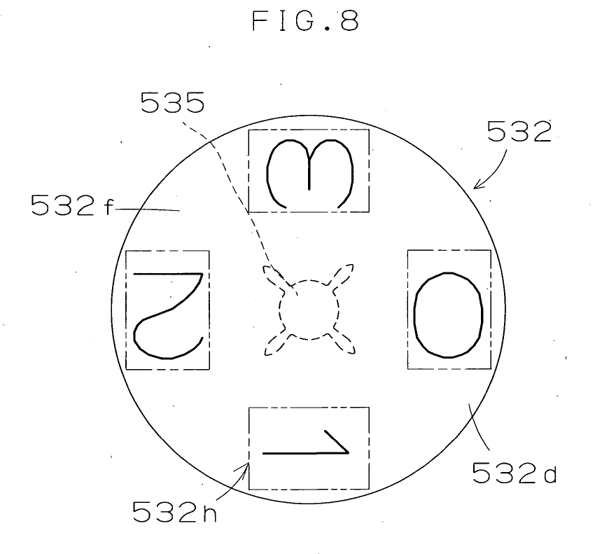

In reference to FIG. 8, the third date indicator 532 includes a third date plate 532d and 4 pieces of third indicator teeth portions formed to configure equal angular intervals. A third date character indicating face 532f is arranged at an upper face of the third date plate 532d. Third date characters 532h comprising 4 pieces of numerals are provided at a third date character indicating face 532f. The third date characters 532h includes numerals in a circumferential direction in an order of “0”, “2”, “2”, and “3”. That is, the third date indicator 532 is provided to indicate a position of 10 of the date, that is, “0”, “1”, “2”, and “3”. 4 pieces of numerals constituting the third date characters 532h are arranged at the third date character indicating face 532f at equal angular intervals, that is, at intervals of (360/4) degrees.

The respective date plates can be formed by a metal of brass, aluminum or the like, or plastic of polyacetal or the like. Respective date characters can be formed by printing or the like. It is preferable to form an outer diameter of the first date indicator 512 by a dimension equal to an outer diameter of the second date indicator 522. Further, it is further preferable to form the outer diameter of the first date indicator 512, the outer diameter of the second date indicator 522 and an outer diameter of the third date indicator 532 by an equal dimension. It is preferable to form a size of individual characters of the first date characters 512h, a size of individual characters of the second date characters 522h, and a size of individual characters of the third date characters 532h by an equal dimension. By the constitution, the calendar mechanism which is large and easy to see can be realized.

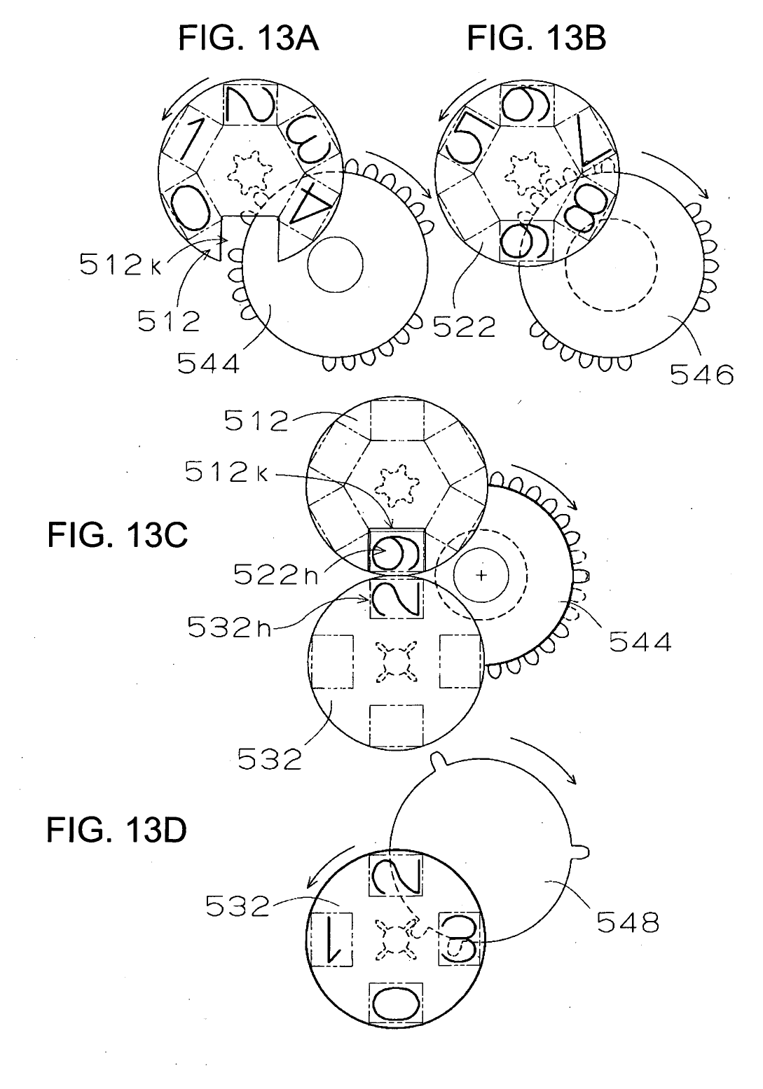

In reference to FIG. 13, FIG. 13 shows a state of indicating that date is “29 day” by providing a date window at a position in 12 o'clock direction of the dial 104 in the timepiece with calendar mechanism of the invention, indicating “9” by the second date indicator 522 and indicating “2” by the third date indicator 532 from the date window.

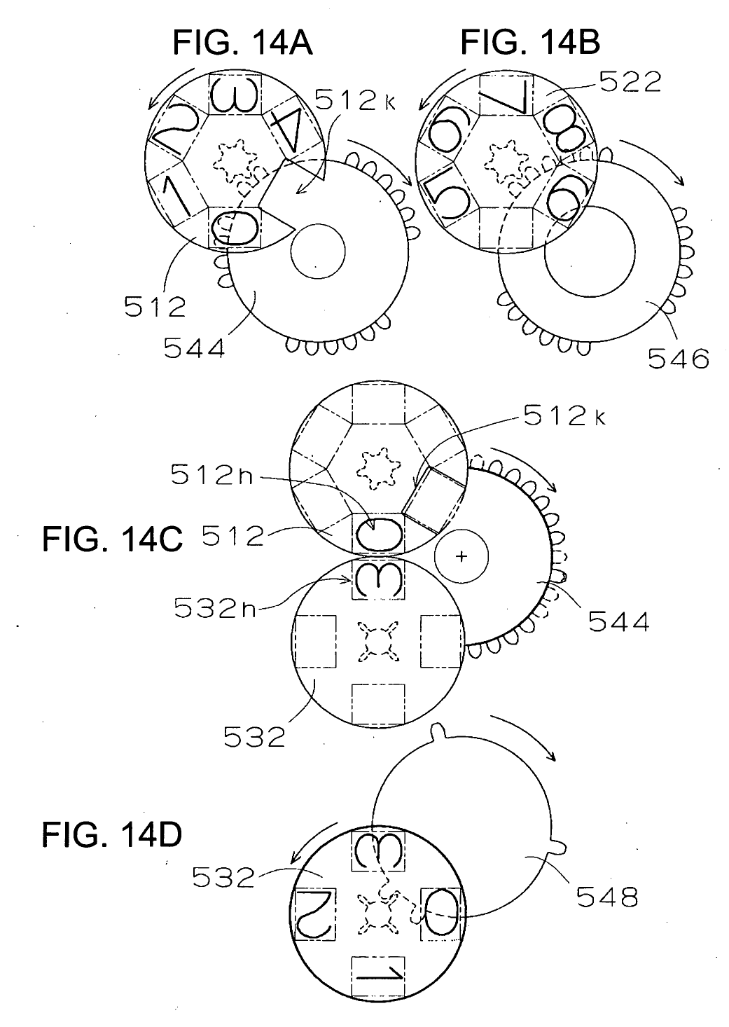

In a state shown in FIG. 14, “0” of the first date character 512h is arranged at the date window 104f provided at the dial 104, when the date indicator 512 is rotated by one pitch in a direction indicated by an arrow mark, “1” in the first date characters 512h is configured to be arranged at the date window 104f. In the following, similarly, when the first date indicator 512 is rotated by one pitch in the direction indicated by the arrow mark, one of the first date characters 512h is arranged at the date window 104f in an order of “2”, “3”, and “4”, next, the notch portion 512k is configured to be arranged at the date window 104f. Further, when the first date indicator 512 is rotated by one pitch in the direction indicated by the arrow mark, “0” of the first date character 512h is configured to be arranged at the date window 104f provided at the dial 104 again. By the constitution, the timepiece with calendar mechanism in which calendar indication is large and easy to see can be realized.

In the state shown in FIG. 14, the first date indicator 512 is disposed on the side of the dial and therefore, the second date character 522h cannot be seen from the date window 104f. When the second date indicator 522 is rotated by one pitch in the direction indicated by the arrow mark in a state of arranging the notch portion 512k at the date window 104f, one of the second date characters 522h is arranged at the date window 104f in an order of “5”, “6”, “7”, “8”, and “9”, next, the “solid portion” 522g is configured to be arranged at the date window 104f. By the constitution, the time piece with calendar mechanism in which calendar indication is large and easy to see can be realized.

In the state shown in FIG. 14, “3” of the third date characters 532h is arranged at the date window 104f, when the third date indicator 532 is rotated by one pitch in the direction indicated by the arrow mark, “0” arranged successive to “3” in the third date characters 532h is configured to be arranged at the date window 104f. In the following, similarly, when the third date indicator 532 is rotated by one pitch in the direction indicated by the arrow mark, one of the third date characters 532h is configured to be arranged at the date window 104f in an order of “1”, “2”, “3”, and “0”. Or, there can be constructed a constitution in which in the third date indicator, instead of providing numeral “0”, the position is configured by a portion of “white paper”, (that is, a solid portion which is not provided with any numeral). By the constitution, a timepiece with calendar mechanism in which indication of a calendar is large and easy to see can be realized.

The state shown in FIG. 14 is a state, in the movement 100, in which “3” in the third date characters 532h is arranged at a portion on a left side of the date window 104f, further, “0” in the first date characters 512h is arranged at a portion on a left side of the date window 104f. It is preferable to arrange the third date character indicating face 532f to a position more proximate to the dial 104 than the first date character indicating face 512f, further, to arrange a position more remote from the dial 104 than the second date character indicating face 522f (refer to FIG. 3). By the constitution, both of a stepped difference between the third date character indicating face 532f and the first date indicating face 512f and a stepped difference between the third date character indicating face 532f and the second date character indicating face 522f can be minimized.

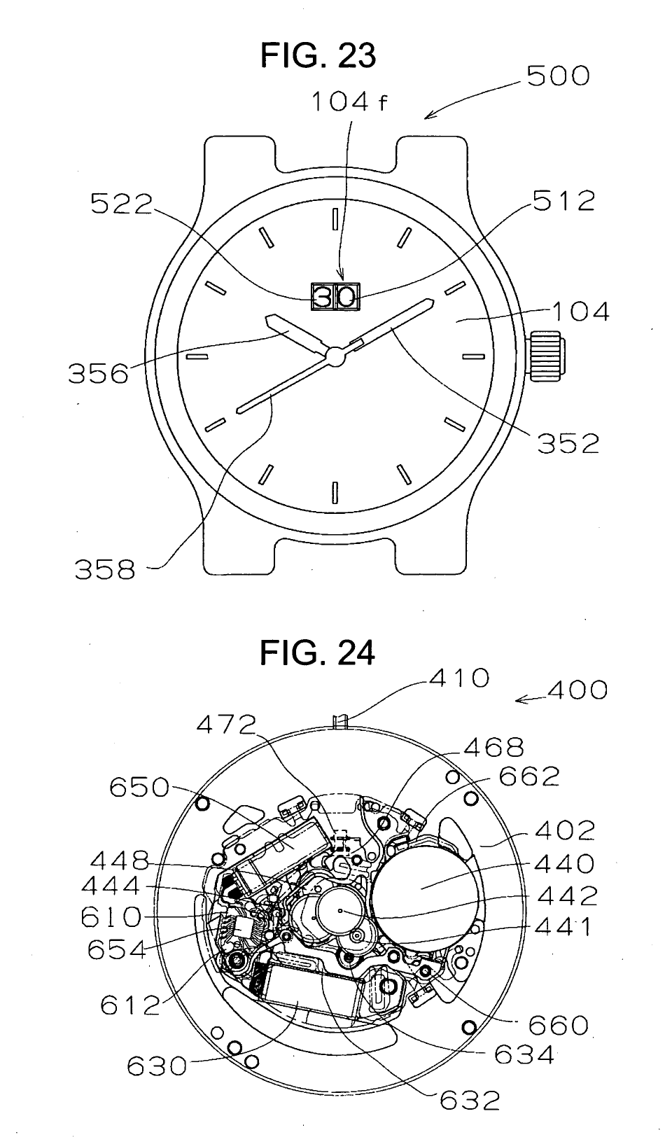

In reference to FIG. 23, a complete 500 of the timepiece with calendar mechanism according to the invention is formed with the date window 104f at 12 o'clock position of the dial 104. In the complete 500, the portion on the left side of the date window 104f of the dial 104 is arranged with “3” in the third date characters 532h of the third date indicator 532, and the portion on the right side of the date window 104f is arranged with “0” in the first date characters 512h of the first date indicator 512. Therefore, FIG. 23 shows a state in which the complete 500 indicates “30 day” by the third date character 532h of the third date indicator 532 and the first date character 512h of the first date indicator 512.

In reference to FIG. 1 through FIG. 4 and FIG. 13, by rotating the hour wheel 354, the date driving wheel & pinion 510 is rotated by way of rotation of the intermediate first date driving wheel & pinion 530, the intermediate second date driving wheel & pinion 531, the date driving finger 511 rotates the program wheel & pinion 540 by an amount of one tooth in the clockwise direction by once per day. By rotating the program wheel & pinion 540, the first program wheel 544 rotates the first date indicator 512 in the counterclockwise direction by an amount of one tooth, and a portion of the first date character indicating face 512f of the first date indicator 512 arranged at the date window 104f can be changed from the notch portion 512k to date character “0”. Rotation of the first date indicator 512 by the amount of one tooth is rectified by the first date indicator jumper 514. Simultaneously with rotating the first date indicator 512 by the first program wheel 544, the second program wheel 546 rotates the second date indicator 522 in the counterclockwise direction by an amount of one tooth, and the date character arranged below the date window 104f of the second date indicator 522 can be changed from “9” to the “solid portion” 522g. Rotation of the second date indicator 522 by the amount of one tooth is rectified by the second date indicator jumper 524.

Further, simultaneously with rotating the first date indicator 512 by the first program wheel 544, the third program wheel 548 rotates the third date indicator 532 in the counterclockwise direction by an amount of one tooth, and the date character arranged below the date window 104f of the first date indicator 532 can be changed from “2” to “3”. Rotation of the third date indicator 532 by the amount of one tooth is rectified by the third date indicator jumper 533. As shown by FIG. 14, by the date driving operation, “30 day” can be indicated from the date window 104f by the third date indicator 532 and the first date indicator 512 by indicating “3” by the second date character 532h of the third date indicator 532 and indicating “0” by the first date character 512h of the first date indicator 512. The date driving operation may be configured to finish when the hour hand 356 and the minute hand 352 indicate 12 o'clock 0 minute.

(1.6) Constitution of Calendar Correcting Mechanism:

In reference to FIG. 1 through FIG. 3, a calendar correcting mechanism includes a first calendar corrector setting wheel 590, a second calendar corrector setting wheel 591, and a calendar corrector setting wheel 592. The calendar corrector setting wheel 592 is configured to be able to be pivoted along a guide hole provided at the main plate 102. When the hand setting stem 310 is pulled from 0 stage to 1 stage, a wheel portion of the setting wheel 376 is configured to be able to be brought in mesh with a wheel portion of the first calendar corrector setting wheel 590 by rotating the setting wheel driving lever 374 based on rotation of the setting lever 370. Further, when the hand setting stem 310 is pulled from 0 stage to 1 stage, an inner side wheel of the clutch wheel 311 is configured to be able to be brought in mesh with a wheel portion of the setting wheel 376 by rotating the yoke 371 based on rotation of the setting lever 370.

When the hand setting stem 310 is rotated in a first direction in a state of pulling the hand setting stem 310 to 1 stage, the clutch wheel 311 is rotated, the second calendar corrector setting wheel 591 is rotated by rotation of the setting wheel 376, and the first calendar corrector setting wheel 590, the calendar corrector setting wheel 592 is pivoted in the counterclockwise direction by rotation of the second calendar corrector setting wheel 591, a wheel portion of the calendar corrector setting wheel 592 is rotated to a position of being brought in mesh with the teeth portion of the program date indicator 542 to be stopped thereby, and the calendar corrector setting wheel 592 is configured to rotate at the calendar correcting position. When the calendar corrector setting wheel 592 is rotated at the calendar correcting position, the calendar corrector setting wheel 592 is configured to be able to rotate the program wheel & pinion 540 in the clockwise direction.

When the hand setting stem 310 is rotated in a second direction reverse to the first direction in the state of pulling the hand setting stem 310 to 1 stage, the clutch wheel 311 is rotated, the second calendar corrector setting wheel 591 is rotated by rotation of the setting wheel 376, and the first calendar corrector setting wheel 590, the calendar corrector setting wheel 592 is pivoted in the clockwise direction by rotation of the second calendar corrector setting wheel 591, and the wheel portion of the calendar corrector setting wheel 592 is rotated to a position of not being brought in mesh with the teeth portion of the program date wheel 542 to stop at an idling position. The program wheel & pinion 540 is configured not to be able to be rotated not even when the calendar corrector setting wheel 592 is rotated at the idling position.

When the hand setting stem 310 is rotated in the first direction in the state of pulling the hand setting stem 310 to 1 stage, the program wheel & pinion 540 is rotated in the clockwise direction by an amount of one tooth by rotating the calendar corrector setting wheel 592 by way of rotation of the clutch wheel 311, the setting wheel 376, the first calendar corrector setting wheel 590, and the second calendar corrector setting wheel 591, the first program wheel 544 can rotate the first date indicator 512, the second program wheel 546 can rotate the second date indicator 522 in the counterclockwise direction by the amount of one tooth by the teeth portion, and the third program wheel 548 is configured to be able to rotate the third date indicator 532 in the counterclockwise direction by the amount of one tooth by the teeth portion.

The timepiece with calendar mechanism according to the invention is constructed by a constitution of indicating from “1 day” to “31 day” each month and therefore, date correction at end of month is carried out only at end of February, end of April, end of June, end of September, and end of November. Therefore, according to the timepiece with calendar mechanism of the invention, a frequency of carrying out date correction at end of month can be configured by 5 times in one year.

(1.7) Normal Hand Operation:

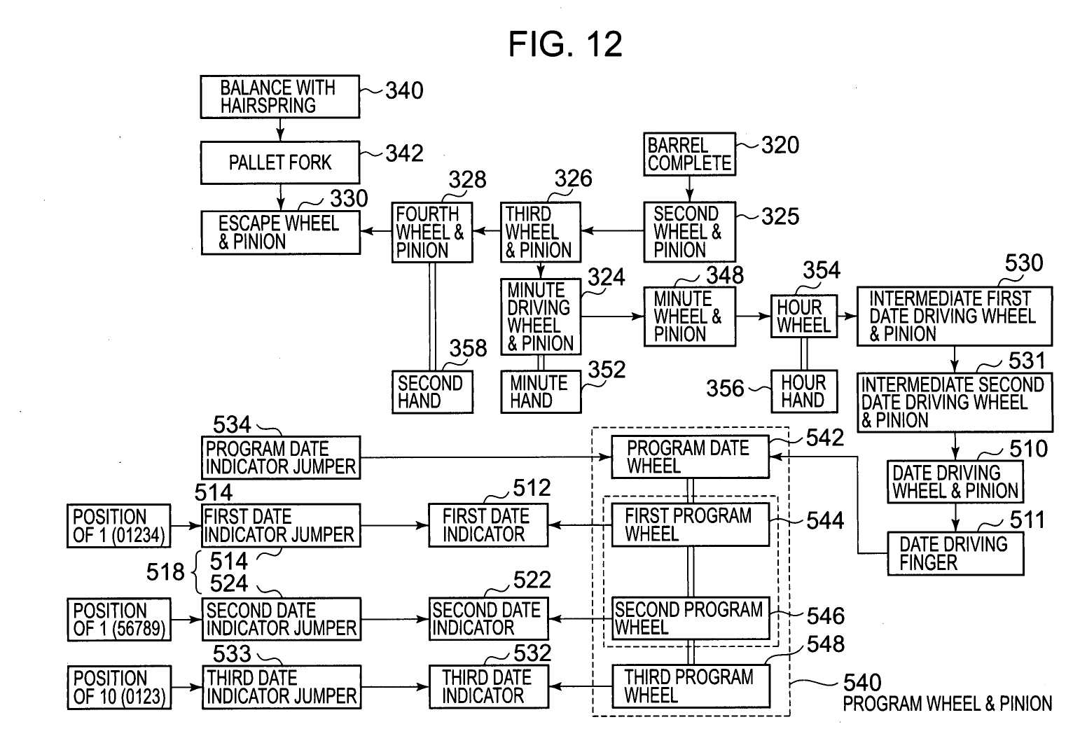

Next, normal operation of hand of the timepiece with calendar mechanism of the invention will be explained. In reference to FIG. 3 through FIG. 6 and FIG. 12, the main spring (not illustrated) integrated to the barrel complete 320 constitutes a power source of the timepiece. By winding back (releasing) the main spring, the barrel wheel 320d of the barrel complete 320 is rotated in one direction to indicate time information by indicators (hour hand, minute hand, second hand or the like) by way of rotation of the top train wheel and the back train wheel. Rotation of the barrel wheel 320d rotated by power of the main spring is controlled by a speed control apparatus and an escapement apparatus. The speed control apparatus includes the balance with hairspring 340. The escapement apparatus includes the pallet fork 342 and the escape wheel & pinion 330. The second wheel & pinion 325 is rotated by rotation of the barrel wheel 320d. By rotation of the second wheel & pinion 325, the third wheel & pinion 326 is rotated. By rotation of the third wheel & pinion 326, the fourth wheel & pinion 328 is rotated by one rotation per 1 minute.

A rotation speed of the fourth wheel & pinion 328 is controlled by the escape wheel & pinion 330. Pivoting movement of the pallet fork 342 is controlled by the balance with hairspring 340. By rotation of the third wheel & pinion 326, the minute driving wheel & pinion 324 is rotated by one rotation per 1 hour. The minute hand 352 attached to the minute driving wheel & pinion 324 indicates “minute”. The second hand 358 attached to the fourth wheel & pinion 328 indicates “second”. The rotational center of the fourth wheel & pinion 328 and the rotational center of the minute driving wheel & pinion 324 are configured to be disposed at the same position. By rotation of the minute driving wheel & pinion 324, the minute wheel & pinion 348 is rotated. By rotation of the minute wheel & pinion 348, the hour wheel 354 is configured to rotate by one rotation per 12 hours. The hour hand 356 attached to the hour wheel 354 indicates “hour”.

(1.8) Winding Operation:

Operation of a hand winding mechanism will be explained in the timepiece with calendar mechanism of the invention as follows. In reference to FIG. 2, FIG. 5 and FIG. 6, the ratchet wheel 316 is supported to rotate integrally with the barrel stem of the barrel complete 320. The ratchet wheel 316 can be rotated only in a direction the same as the direction of rotating the barrel complete 320. A click 318 constituting a member of rectifying rotation of the ratchet wheel is provided at the barrel complete 360 for rectifying rotation of the ratchet wheel 316 only in one direction. By the click 318, the ratchet wheel 316 can be hampered from rotating in the direction reverse to the direction of rotating the barrel complete 320. When the clutch wheel 311 is rotated in one direction in a state in which the hand setting stem 310 is disposed at 0 stage, the winding pinion 312 is rotated, by rotation of the winding pinion 312, the ratchet wheel 316 is rotated in the clockwise direction by way of rotation of the crown wheel 313, a crown transmission wheel 314, the pivoting crown wheel 315. By rotating the ratchet wheel 316, the main spring can be wound.

Next, operation of an automatic winding mechanism will be explained in the timepiece with calendar mechanism according to the invention. In reference to FIG. 3 through FIG. 6, according to the automatic winding mechanism, the first transmission wheel & pinion 212 is rotated based on rotation of the oscillating weight 210. The second transmission wheel & pinion 216 is rotated based on rotation of the first transmission wheel & pinion 212. The switch transmission pinion of the switch transmission wheel & pinion 220 is rotated only in one direction based on rotation of the first transmission wheel & pinion 212 and the second transmission wheel & pinion 216. Based on rotation of the switch transmission pinion, the ratchet wheel 316 can be rotated only in one direction by way of rotation of the first reduction wheel & pinion 250, the second reduction wheel & pinion 252, the third reduction wheel & pinion 254. By rotating the ratchet wheel 316, the main spring at inside of the barrel complete 320 can be wound up only in one direction.

(1.9) Hand Setting Operation:

Next, operation when hand setting is carried out will be explained in the timepiece with calendar mechanism according to the invention. When the hand setting stem 310 is pulled out from the state shown in FIG. 2, the clutch wheel 311 is rotated based on rotation of the hand setting stem 310. That is, when the hand setting stem 310 is rotated in the state of pulling out the hand setting stem 310 to 2 stage, the setting wheel 376 is rotated based on rotation of the clutch wheel 311. The minute wheel & pinion 348 is rotated based on rotation of the clutch wheel 376. Therefore, when the hand setting stem 310 is disposed at 2 stage, by rotating the hand setting stem 310, “hand setting” can be carried out. That is, when the hand setting stem 310 is disposed at 2 stage, by rotating the hand setting stem 310, the hour wheel 354 is rotated, a content of indicating “hour” indicated by the hour hand 356 attached to the hour wheel 354 is corrected, at the same time, a content of indicating “minute” indicated by the minute hand 352 attached to the minute driving wheel & pinion 324 can be corrected by rotating the minute driving wheel & pinion 324.

(1.10) Calendar Driving Operation:

Next, a calendar driving operation of the timepiece with calendar mechanism according to the invention will be explained. In reference to FIG. 13, a state shown in FIG. 13 is a state of indicating that the date is “29 day” by providing the date window at the position in 12 o'clock direction of the dial 104, indicating “9” by the second date indicator 522 from the date window and indicating “2” by the third date indicator 532. Therefore, the state shown in FIG. 13 is a state of indicating “29 day” by the third date character 532h of the third date indicator 532 and the second date character 522h of the second date indicator 522 in the complete 500.

In reference to FIG. 1 through FIG. 4 and FIG. 13, by rotating the hour wheel 354, the date driving wheel & pinion 510 is rotated by way of rotation of the intermediate first date driving wheel & pinion 530, the intermediate second date driving wheel & pinion 531, the date driving finger 511 rotates the program wheel & pinion 540 in the clockwise direction by an amount of one tooth by one time per 1 day. By rotating the program wheel & pinion 540, the first program wheel 544 rotates the first date indicator 512 in the counterclockwise direction by an amount of one tooth, and the portion of the first date character indicating face 512f of the first date indicator 512 arranged at the date window 104f is changed from the notch portion 512k to the date character “0”. Rotation of the first date indicator 512 by an amount of one tooth is rectified by the first date indicator jumper 514. Simultaneously with rotating the first date indicator 512 by the first program wheel 544, the second program wheel 546 rotates the second date indicator 522 in the counterclockwise direction by an amount of one tooth, and the date character of the second date indicator 522 arranged under the date window 104f is changed from “9” to the “solid portion” 522g. Rotation of the second date indicator 522 by an amount of one tooth is rectified by the second date indicator jumper 524.

Simultaneously with rotating the first date indicator 512 by the first program wheel 544, the third program wheel 548 rotates the third date indicator 522 in the counterclockwise direction by an amount of one tooth, and the date character of the third date indicator 532 arranged under the date window 104f is changed from “2” to “3”. Rotation of the third date indicator 532 by an amount of one tooth is rectified by the third date indicator jumper 533. As shown by FIG. 14, by the date driving operation, “3” can be indicated by the third date character 532h of the third date wheel 532, “0” can be indicated by the first date character 512h of the first date wheel 512, and “30 day” can be displayed from the date window 104f by the third date indicator 532 and the first date indicator 512. The date driving operation is finished when the hour hand 356 and the minute hand 352 indicate 12 o'clock 0 minute.

In reference to FIG. 1 through FIG. 4 and FIG. 14, further, by rotating the hour wheel 354, the date driving wheel & pinion 510 is rotated by way of rotation of the intermediate first date driving wheel & pinion 530, the intermediate second date driving wheel & pinion 531, the date driving finger 511 rotates the program wheel & pinion 540 in the clockwise direction by an amount of one tooth by one time per 1 day. By rotating the program wheel & pinion 540, the first program wheel 544 rotates the first date indicator 512 in the counterclockwise direction by an amount of one tooth, and the date character “0” of the first date indicator 512 arranged at the date window 104f is changed to “1”. Rotation of the first date indicator 512 by an amount of one tooth is rectified by the first date wheel jumper 514.

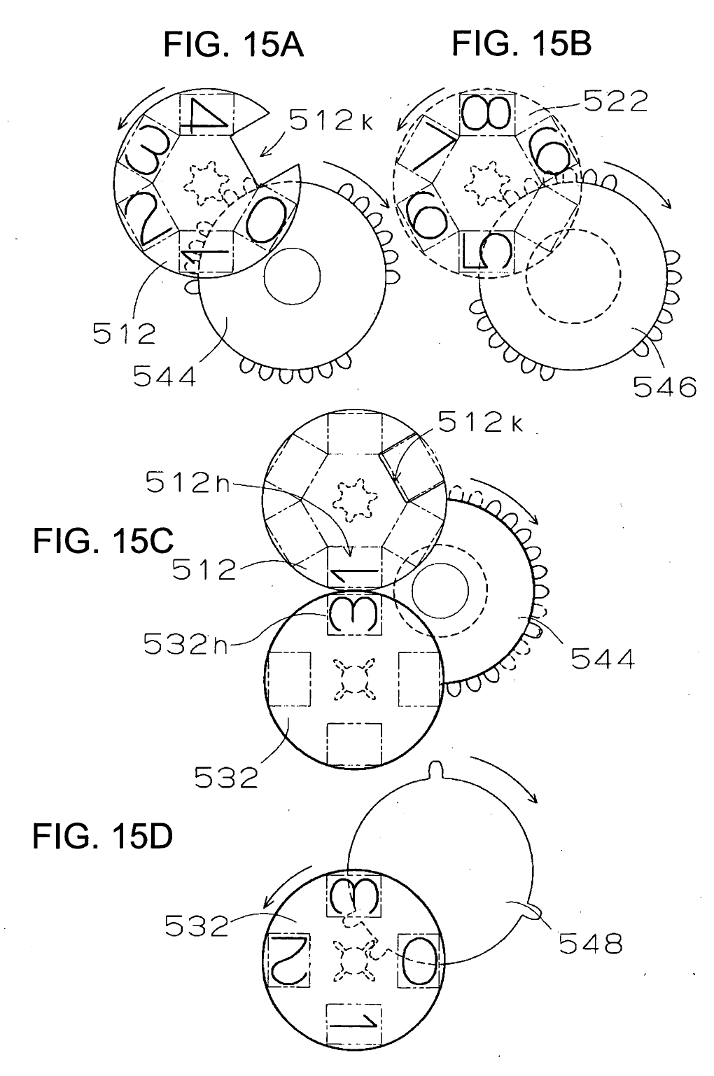

Simultaneously with rotating the first date indicator 512 by the first program wheel 544, the second program wheel 546 rotates the second date indicator 522 by an amount of one tooth in the counterclockwise direction, and the “solid portion” 522g of the second date indicator 522 arranged under the date window 104f is changed to the date character “5”. Rotation of the second date indicator 522 by an amount of one tooth is rectified by the second date indicator jumper 524. When the first program wheel 544 rotates the first date indicator 512, the third program wheel 548 does not rotate the third date indicator 532 but the date character of the third date indicator 532 arranged under the date window 104f stays to be “3”. Rotation of the third date indicator 532 is rectified by the third date indicator jumper 533. As shown by FIG. 15, by the date driving operation, “3” can be indicated by the third date character 532h of the third date indicator 532, “1” can be indicated by the first date character 512h of the first date indicator 512, and “31 day” can be indicated by the third date indicator 532 and the first date indicator 512.

In reference to FIG. 1 through FIG. 4 and FIG. 15, further, by rotating the hour wheel 354, the date driving wheel & pinion 510 is rotated by way of rotation of the intermediate first date driving wheel & pinion 530, the intermediate second date driving wheel & pinion 531, and the date driving finger 511 rotates the program wheel & pinion 540 in the clockwise direction by an amount of one tooth by one time per 1 day. By rotating the program wheel & pinion 540, the first program wheel 544 does not rotate the first date indicator 512 but the date character of the first date indicator 512 arranged under the date window 104f stays to be “1”. Rotation of the first date indicator 512 is rectified by the first date indicator jumper 514. By rotating the program wheel & pinion 540, the second program wheel 546 does not rotate the second date indicator 522 but the date character of the second date indicator 522 arranged under the date window 104f stays to be “5”.

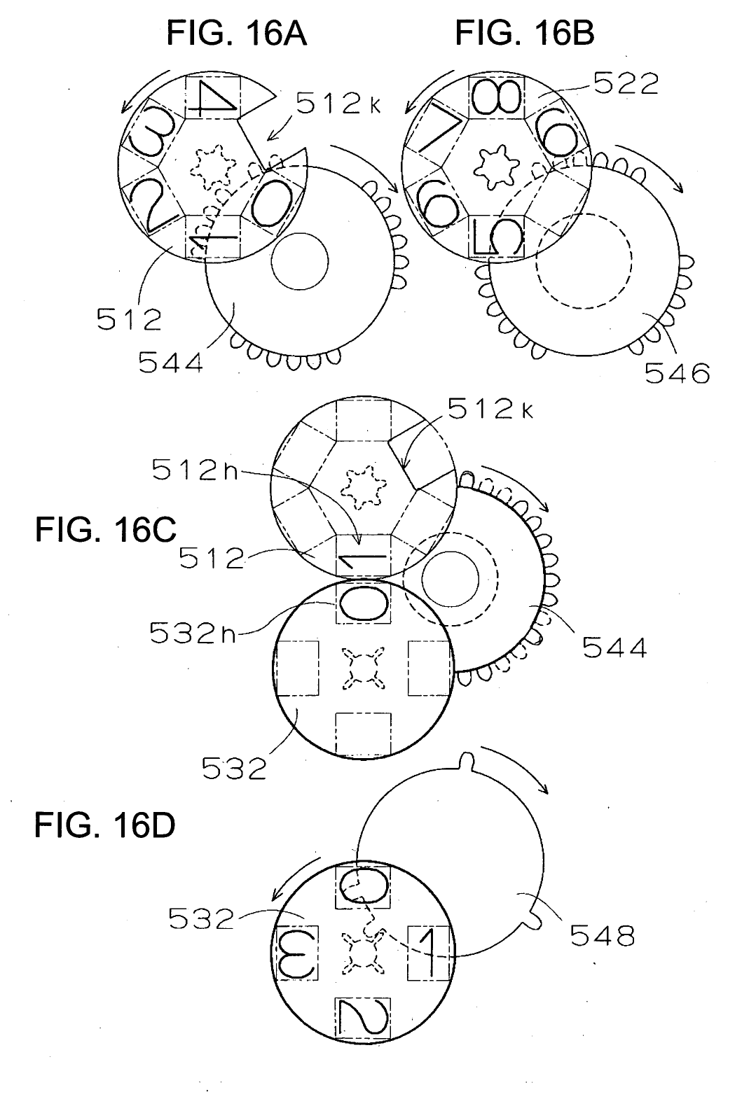

Rotation of the second date indicator 522 is rectified by the second date indicator jumper 524. By rotating the program wheel & pinion 540, the third program wheel 548 rotates the third date indicator 532 in the counterclockwise direction by an amount of one tooth, and the date character of the third date indicator 532 arranged under the date window 104f is changed from “3” to “0”. Rotation of the third date indicator 532 is rectified by the third date indicator jumper 533. As shown by FIG. 16, by the date driving operation, “0” can be indicated by the third date character 532h of the third date indicator 532, “1” can be indicated by the first date character 512h of the first date indicator 512, and “01 day” (that is, “1 day”) can be indicated by the third date indicator 532 and the first date indicator 512 from the date window 104f.

In reference to FIG. 1 through FIG. 4 and FIG. 16, further, by rotating the hour wheel 354, the date driving wheel & pinion 510 is rotated by way of rotation of the intermediate first date driving wheel & pinion 530, the intermediate second date driving wheel & pinion 531, and the date driving finger 511 rotates the program wheel & pinion 540 in the clockwise direction by an amount of one tooth by one time per 1 day. By rotating the program wheel & pinion 540, the first program wheel 544 rotates the first date indicator 512 in the counterclockwise direction by an amount of one tooth, and the date character of the first date indicator 512 arranged under the date window 104f is changed from “1” to “2”. At this occasion, the second program wheel 546 does not rotate the second date indicator 522 but the date character of the second date indicator 522 arranged under the date window 104f stays to be “5”, the third program wheel 548 does not rotate the third date indicator 532 but the date character of the second date indicator 522 arranged under the date window 104f stays to be “0”.

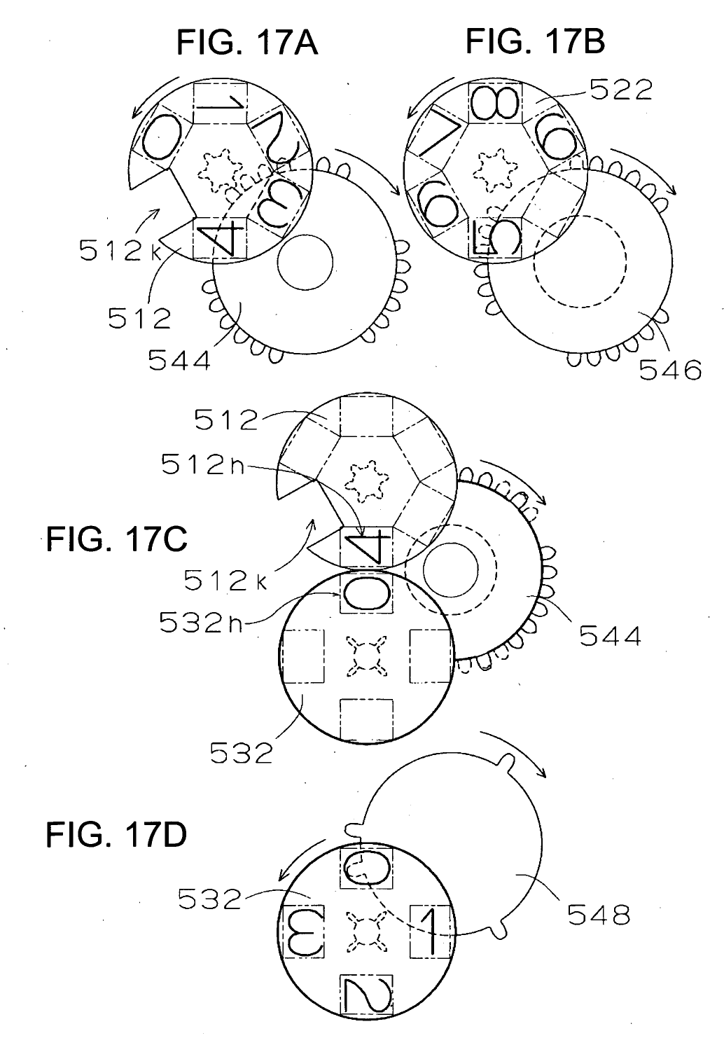

Similarly, by rotating the program wheel & pinion 540, the date character of the first date indicator 512 arranged under the date window 104f is changed from “2” to “3”. Further, by rotating the program wheel & pinion 540, the date character of the first date indicator 512 arranged under the date window 104f is changed from “3” to “4”. As shown by FIG. 17, by the date driving operation, “0” can be indicated by the third date character 532h of the third date indicator 532, “4” can be indicated by the first date character 512h of the first date indicator 512, and “04 day” (that is, “4 day”) can be indicated from the date window 104f by the third date indicator 532 and the first date indicator 512.

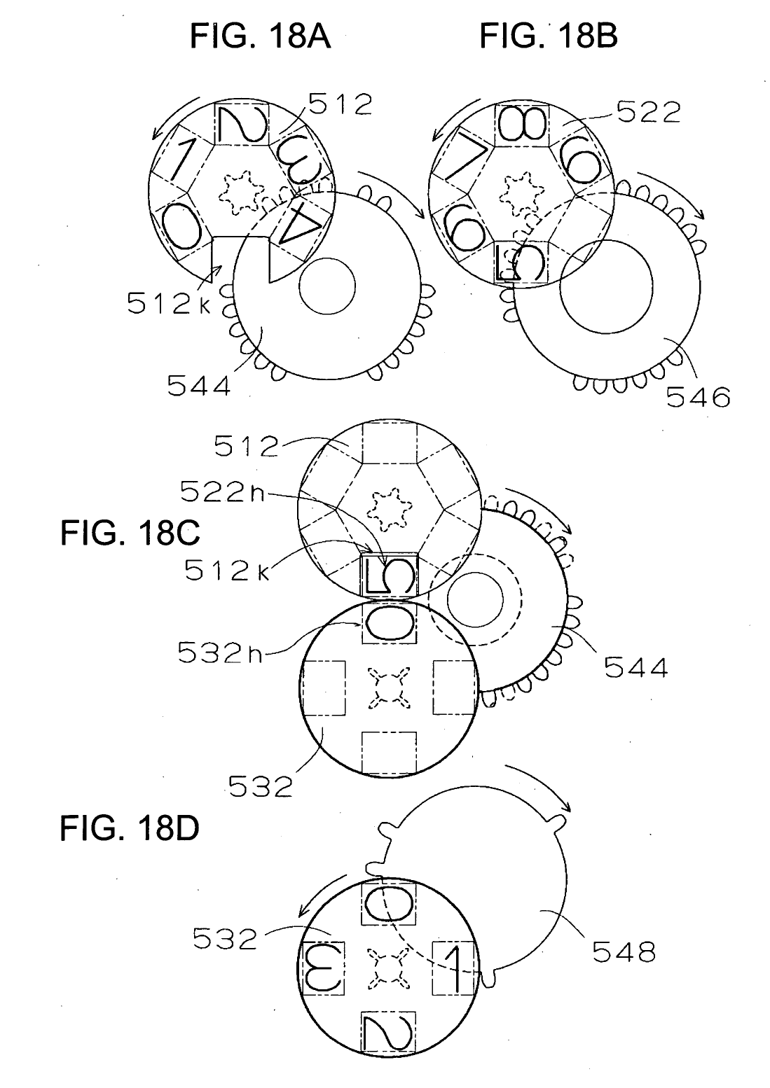

In reference to FIG. 1 through FIG. 4 and FIG. 17, by rotating the hour wheel 354, the date driving wheel & pinion 510 is rotated by way of rotation of the intermediate first date driving wheel & pinion 530, the intermediate second date driving wheel & pinion 531, and the date driving finger 511 rotates the program wheel & pinion 540 in the clockwise direction by an amount of one tooth by one time per 1 day. By rotating the program wheel & pinion 540, the first program wheel 544 rotates the first date indicator 512 in the counterclockwise direction by an amount of one tooth, and the portion of the first date indicator 512 arranged under the date window 104f is changed from “0” to the notch portion 512k. Rotation of the first date indicator 512 by an amount of one tooth is rectified by the first date indicator jumper 514. At this occasion, the second program wheel 546 does not rotate the second date indicator 542 but the date character of the second date indicator 522 arranged under the date window 104f stays to be “5”, the third program wheel 548 does not rotate the third date indicator 532 but the date character of the second date indicator 522 arranged under the date window 104f stays to be “0”. As shown by FIG. 18, by the date driving operation, “0” can be indicated by the third date character 532h of the third date indicator 532, “5” can be indicated by the second date character 522h of the second date indicator 522, and “05 day”, (that is, “5 day”) can be indicated from the date window 104f of the third date indicator 532 and the second date indicator 522.

In reference to FIG. 1 through FIG. 4 and FIG. 18, by rotating the hour wheel 354, the date driving wheel & pinion 510 is rotated by way of rotation of the intermediate first date driving wheel & pinion 530, the intermediate second date driving wheel & pinion 531, and the date driving finger 511 rotates the program wheel & pinion 540 in the clockwise direction by an amount of one tooth by one time per 1 day. By rotating the program wheel & pinion 540, the first program wheel 544 does not rotate the first date indicator 512 but the portion of the first date indicator 512 arranged under the date window 104f stays to be the notch portion 512k. Rotation of the first date indicator 512 is rectified by the first date indicator jumper 514. By rotating the program wheel & pinion 540, the second program wheel 546 rotates the second date indicator 522 in the counterclockwise direction by an amount of one tooth, and the date character of the second date indicator 522 arranged under the date window 104f is changed from “5” to “6”. At this occasion, the third program wheel 548 does not rotate the third date indicator 532 but the date character of the second date indicator 522 arranged under the date window 104f stays to be “0”.

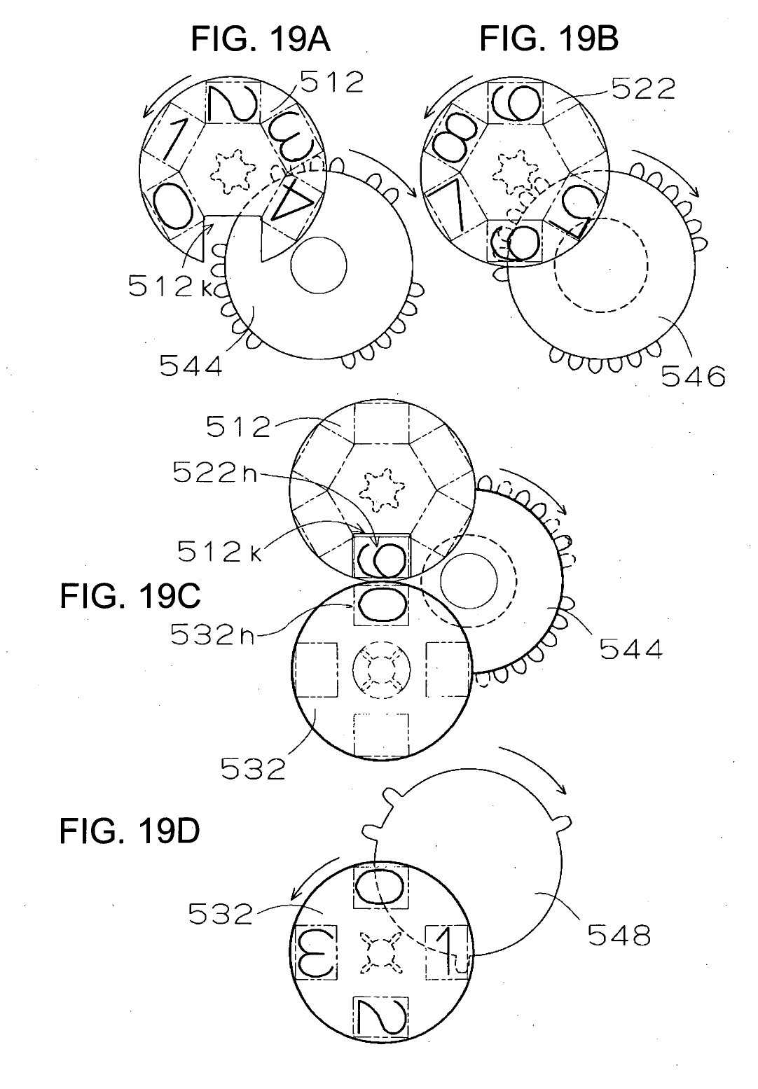

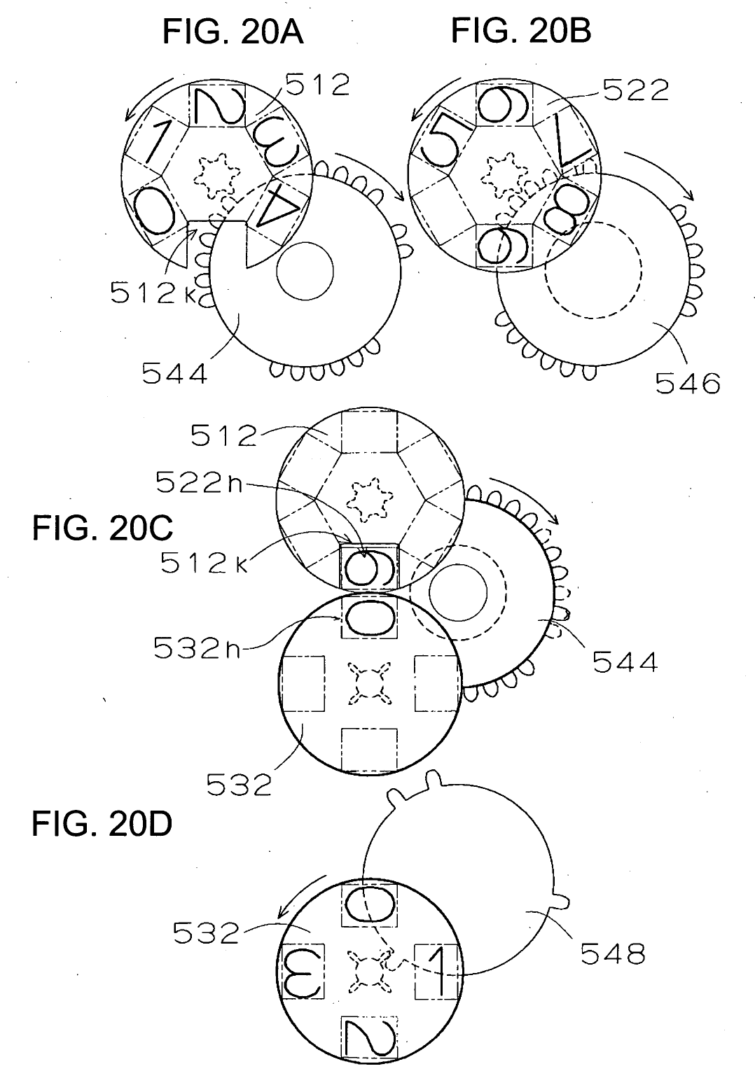

As shown by FIG. 19, by the date driving operation, “0” can be indicated by the third date character 532h of the third date indicator 532, “6” can be indicated by the second date character 522h of the second date indicator 522, and “06 day” (that is, “6 day”) can be indicated from the date window 104f by the third date indicator 532 and the second date indicator 522. Similarly, by rotating the program wheel & pinion 540, the date character of the second date indicator 522 arranged under the date window 104f is changed from “6” to “7”. Further, by rotating the program wheel & pinion 540, the date character of the second date indicator 522 arranged under the date window 104f is changed from “7” to “8”. Further, by rotating the program wheel & pinion 540, the date character of the second date indicator 522 arranged under the date window 104f is changed from “8” to “9”. As shown by FIG. 20, by the date driving operation, “0” can be indicated by the third date character 532h of the third date indicator 532, “9” can be indicated by the second date character 522h of the second date indicator 522, and “09 day” (that is, “9 day”) can be indicated from the date window 104f by the third date indicator 532 and the second date indicator 522.

In reference to FIG. 1 through FIG. 4 and FIG. 20, further, by rotating the hour wheel 354, the date driving wheel & pinion 510 is rotated by way of rotation of the intermediate first date driving wheel & pinion 530, the intermediate second date driving wheel & pinion 531, and the date driving finger 511 rotates the program wheel & pinion 540 in the clockwise direction by an amount of one tooth by one time per 1 day. By rotating the program wheel & pinion 540, the first program wheel 544 rotates the first date indicator 512 in the counterclockwise direction by an amount of one tooth, and the portion of the first date indicator 512 arranged under the date window 104f is changed from the notch portion 512k to the date character “0”. Rotation of the first date indicator 512 by the amount of one tooth is rectified by the first date indicator jumper 514.

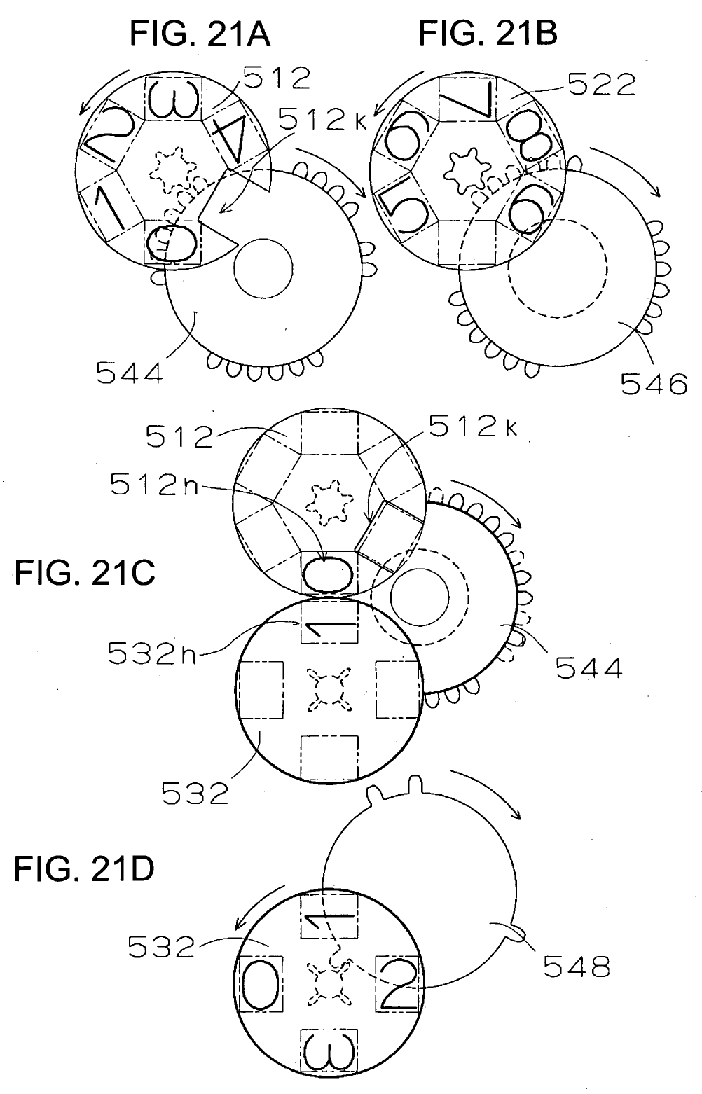

Simultaneously with rotating the first date indicator 512 by the first program wheel 544, the second program wheel 546 rotates the second date indicator 522 in the counterclockwise direction by an amount of one tooth, and the date character “9” of the second date indicator 522 arranged under the date window 104f is changed to “solid portion” 522g. Rotation of the second date indicator 522 an the amount of one tooth is rectified by the second date indicator jumper 524. Simultaneously with rotating the first date indicator 512 by the first program wheel 544, the second program wheel 546 rotates the third date indicator 532 in the counterclockwise direction by an amount of one tooth, and the date character of the third date indicator 532 arranged under the date window 104f is changed from “0” to “1”. Rotation of the third date indicator 532 is rectified by the third date indicator jumper 533. As shown by FIG. 21, by the date driving operation, “1” can be indicated by the third date character 532h of the third date indicator 532, “0” can be indicated by the first date character 512h of the first date indicator 512, and “10 day” can be indicated from the date window 104f by the third date indicator 532 and the first date indicator 512.

In reference to FIG. 1 through FIG. 4 and FIG. 21, further, by rotating the hour wheel 354, the date driving wheel & pinion 510 is rotated by way of rotation of the intermediate first date driving wheel & pinion 530, the intermediate second date driving wheel & pinion 531, and the date driving finger 511 rotates the program wheel & pinion 540 in the clockwise direction by an amount of one tooth by one time per 1 day. By rotating the program wheel & pinion 540, the first program wheel 544 rotates the first date indicator 512 in the counterclockwise direction by an amount of one tooth, and the date character “0” of the first date indicator 512 arranged under the date window 104f is changed to “1”. Rotation of the first date indicator 512 by an amount of one tooth is rectified by the first date indicator jumper 514. Simultaneously with rotating the first date indicator 512 by the first program wheel 544, the second program wheel 546 rotates the second date wheel 522 in the counterclockwise direction by the amount of one tooth, and the portion of the second date indicator 522 arranged under the date window 104f is changed from the “solid portion” 522g to the date character “5”. Rotation of the second date indicator 522 by the amount of one tooth is rectified by the second date indicator jumper 524.

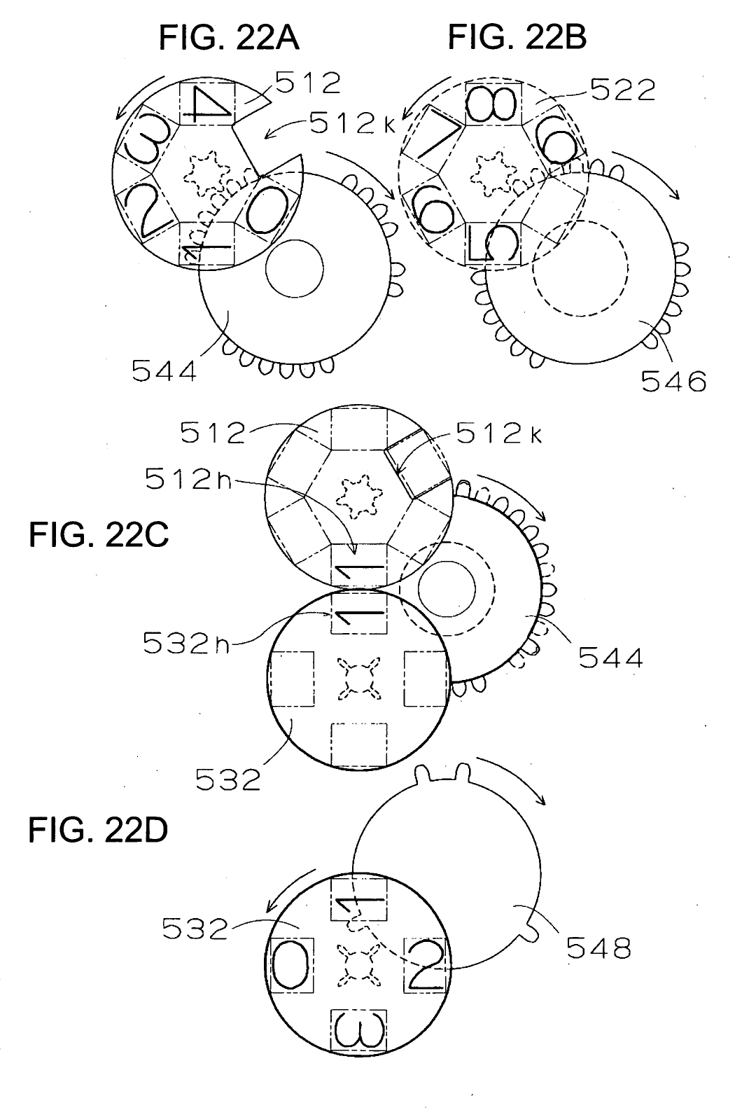

At this occasion, the third program wheel 548 does not rotate the third date indicator 532 but the date character of the third date indicator 532 arranged under the date window 104f stays to be “1”. As shown by FIG. 22, by the date driving operation, “1” can be indicated by the third date character 532h of the third date indicator 532, “1” can be indicated by the first date character 512h of the first date indicator 512, and “11 day” can be indicated from the date window 104f by the third date indicator 532 and the first date indicator 512.

The timepiece with calendar mechanism of the invention can carry out the above-described operation by one time everyday, the portion of the position of 1 of the date (that is, “0”, “1”, “2”, “3”, and “4”) can be indicated by the first date indicator 512, other portion of the position of 1 of the date (that is, “5”, “6”, “7”, “8”, and “9”) can be indicated by the second date indicator 522, and the position of 10 of the date (that is, “0”, “1”, “2”, and “3”) can be indicated by the third date indicator 532 and therefore, “01 day” through “31 day” can be indicated from the date window 104f by large characters.

(1.11) Date Correcting Operation:

Next, an explanation will be given of operation when date is corrected in the timepiece with calendar mechanism according to the invention. In reference to FIG. 1 through FIG. 3, in the state of pulling the hand setting stem 310 to 1 stage, when the hand setting stem 310 is rotated in the first direction, the clutch wheel 311 is rotated, the second calendar corrector setting wheel 591 is rotated by rotation of the setting wheel 376, and the first calendar corrector setting wheel 590, the calendar corrector setting wheel 592 is pivoted in the counterclockwise direction by rotation of the second calendar corrector setting wheel 591, the wheel portion of the calendar corrector setting wheel 592 is rotated to the position of being brought into mesh with the teeth portion of the program date wheel 542 to stop, and the calendar corrector setting wheel 592 is rotated at the calendar correcting position. When the calendar corrector setting wheel 592 is rotated at the calendar correcting position, the program wheel & pinion 540 can be rotated in the clockwise direction by rotating the calendar corrector setting wheel 592.

In reference to FIG. 1 through FIG. 3 and FIG. 12, in the state of pulling the hand setting stem 310 to 1 stage, when the hand setting stem is rotated in the first direction, the program wheel & pinion 540 is rotated in the clockwise direction by an amount of one tooth by rotating the calendar corrector setting wheel 592 by way of rotation of the clutch wheel 311, the setting wheel 376, the first calendar corrector setting wheel 590, and the second calendar corrector setting wheel 591, the first program wheel 544 rotates the first date indicator 512 in the counterclockwise direction by an amount of one tooth, and the date character indicated from the date window 104f can be changed from “9” to “0” by the first date indicator 512. Simultaneously with rotating the first date indicator 512 by the first program wheel 544, the third program wheel 548 rotates the third date indicator 532 in the counterclockwise direction by an amount of one tooth, and the date character indicated from the date window 104f can be changed from “2” to “3” by the third date indicator 532. As shown by FIG. 14, when the correcting operation is carried out, “3” can be indicated by the third date character 532h of the third date indicator 532, “0” can be indicated by the first date character 512h of the first date indicator 512, and “30 day” can be indicated from the date window 104f by the third date indicator 532 and the first date indicator 512.

### (2) Second Embodiment

Next, a second embodiment of a timepiece with calendar mechanism according to the invention will be explained. In the following explanation, a description will mainly be given of a point in which the second embodiment of the timepiece with calendar mechanism of the invention differs from the first embodiment of the timepiece with calendar mechanism of the invention. Therefore, the above-described explanation of the first embodiment of the timepiece with calendar mechanism of the invention will be applied to a portion which is not described below. The second embodiment of the timepiece with calendar mechanism according to the invention is an analog electronic timepiece.

(2.1) Total Constitution of Movement:

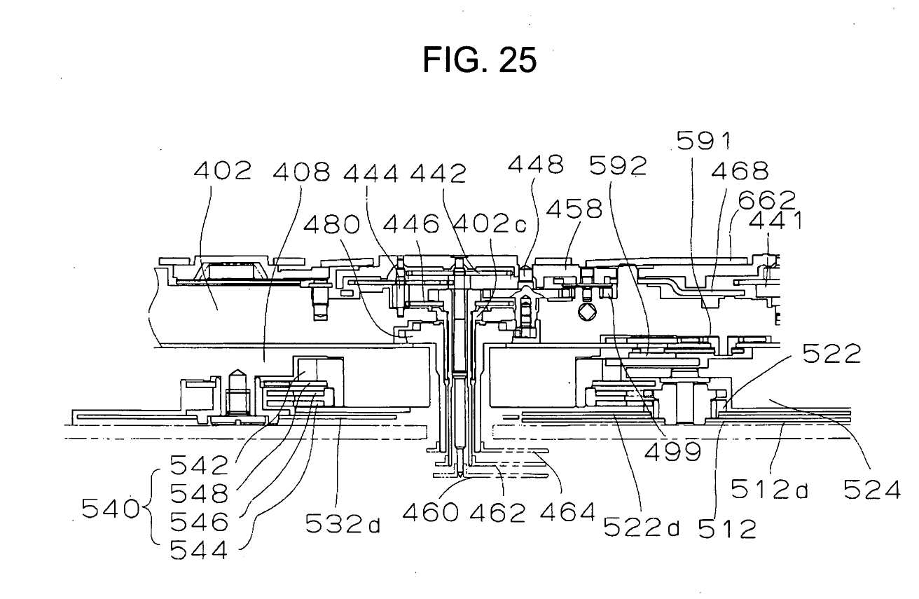

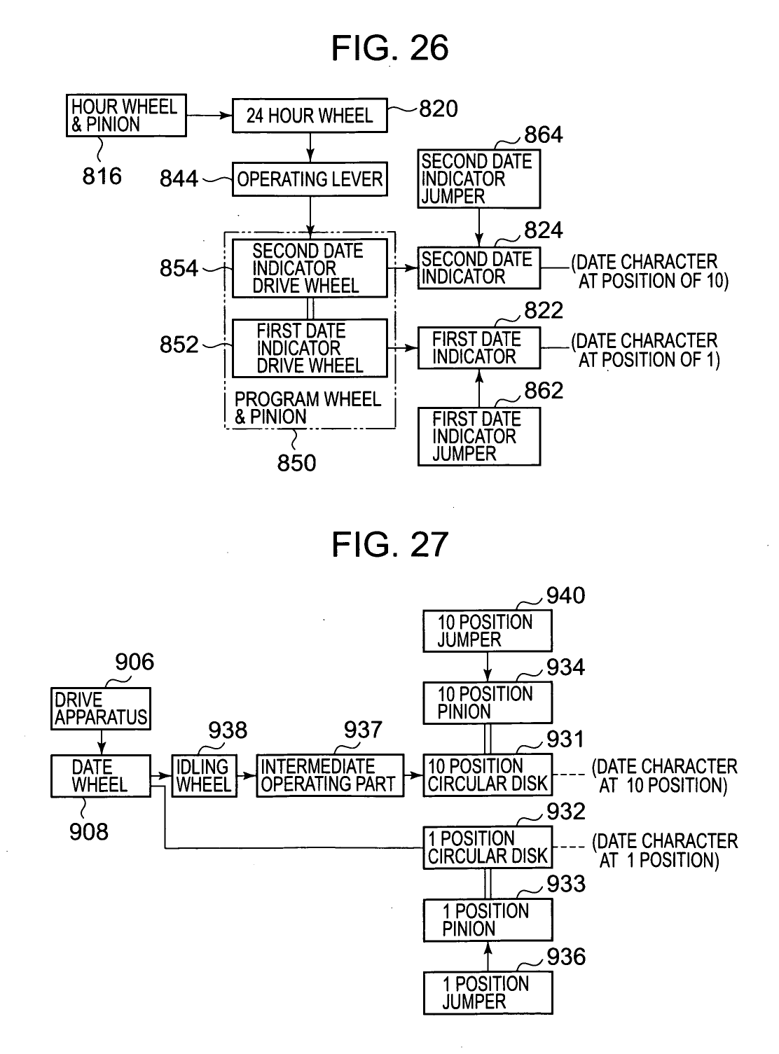

In reference to FIG. 24 and FIG. 25, in the second embodiment of the timepiece with calendar mechanism according to the invention, a movement 400 is configured by an analog electronic timepiece. The movement 400 includes a main plate 402 constituting a base plate of the movement 400. A dial 404 is attached to the movement 400. A hand setting stem 410 is rotatably integrated to the main plate 402. A clutch wheel 472 is arranged to be provided with a rotation axis line the same as a rotation axis line of the hand setting stem 410. A battery 440 constituting a power source of the timepiece is arranged on a case back side (top side) of the main plate 402. A quartz unit 650 constituting an oscillation source of the timepiece is arranged on the case back side of the main plate 402. For example, a crystal oscillator oscillated at 32,768 Hertz is contained in the quartz unit 650.

An oscillating portion (oscillator) for outputting a reference signal based on oscillation of the crystal oscillator, a dividing control portion for controlling operation of a step motor by dividing an output signal of the oscillating portion, and a motor driving portion (driver) for outputting a motor drive signal for driving the step motor based on an output signal of the dividing control portion are included in an integrated circuit (IC) 654. The integrated circuit 654 is configured by, for example, C-MOS or PLA. When the integrated circuit 654 is configured by C-MOS, the oscillating portion, the dividing control portion, and the motor driving portion are included in the integrated circuit 654. When the integrated circuit (IC) 654 is configured by PLA, the oscillating portion, the diving control portion, and the motor driving portion are configured to operate by a program stored to PLA.

The quartz unit 650 and the integrated circuit 654 are fixed to a circuit board 610. The circuit board 610, the quartz unit 650, and the integrated circuit 650 constitute a circuit block 612. The circuit block 612 is arranged on the case base side of the main plate 402. The timepiece with calendar of the invention can use outward-attached elements of a resistor, a condenser, a coil, a diode and the like as necessary. A battery terminal (−) 660 is provided for conducting a negative pole of the battery 440 and a minus pattern of the circuit board 610. A battery terminal (+) 662 is provided for conducting a positive pole of the battery 440 and a plus pattern of the circuit board 610.

A coil block 630 including a coil wire wound around a magnetic core, a stator 632 arranged to be brought into contact with both end portions of the magnetic core of the coil block 630, and a rotor 634 including a rotor magnet 634b arranged at the rotor hole 632c of the stator 632 are arranged on the case back side of the main plate 402. The coil block 630, the stator 632, and the rotor 634 constitutes the step motor. A fifth wheel & pinion 441 is configured to rotate by rotation of the rotor 634. A fourth wheel & pinion 442 is configured to rotate by rotation of the fifth wheel & pinion 441. A third wheel & pinion 444 is configured to rotate by rotation of the fourth wheel & pinion 442. A second wheel & pinion 446 is configured to rotate by rotation of the third wheel & pinion 444. A minute wheel & pinion 448 is configured to rotate by rotation of the second wheel & pinion 446. An hour wheel 480 is configured to rotate by rotation of the minute wheel & pinion 448.

The fourth wheel & pinion 442 is configured to rotate by one rotation per 1 minute. A second hand 460 is attached to the fourth wheel & pinion 442. The second wheel & pinion 446 is configured to rotate by one rotation per 1 hour. A minute hand 462 is attached to the second wheel & pinion 446. A slip mechanism is attached to the second wheel & pinion 446. When hands are set by the slip mechanism, by rotating the hand setting stem 410 in a state of stopping the second hand 460, the minute hand 462 and an hour hand 464 can be rotated. When the hands are set by pulling the hand setting stem 410 to 2 stage, in order to stop rotation of the second hand 460 by rectifying a wheel portion of the fifth wheel & pinion 441, a rectifying lever 468 is provided. A center pipe 402c is fixed to the main plate 402. The center pipe 402c is extended from the case back side of the main plate 402 to the dial side of the main plate 402. The second wheel & pinion 446 is rotatably supported at inside of a hole portion of the center pipe 402c. An abacus bead of the fourth wheel & pinion 442 is rotatably supported at inside of a hole portion of the second wheel & pinion 446.

A train wheel bridge 458 is arranged on the case back side of the main plate 402. An upper shaft portion of the rotor 634, an upper shaft portion of the fifth wheel & pinion 441, an upper shaft portion of the fourth wheel & pinion 442, an upper shaft portion of the third wheel & pinion 444, and an upper shaft portion of the minute wheel & pinion 448 are rotatably supported by the train wheel bridge 458. A lower shaft portion of the rotor 634, a lower shaft portion of the fifth wheel & pinion 441, a lower shaft portion of the third wheel & pinion 444, and a lower shaft portion of the minute wheel & pinion 448 are rotatably supported by the main plate 402. The hour wheel 480 is configured to rotate by one rotation per 12 hours. The hour hand 464 is attached to the hour wheel 480. By the hour hand 464 attached to the hour wheel 480, “hour” is indicated by “12 hour system” constituting 12 hours by one turn. The minute wheel & pinion 448 is arranged to be brought into mesh with the setting wheel 449. The setting wheel 449 is arranged between the main plate 402 and the train wheel bridge 458. A minute pinion (not illustrated) of the minute wheel & pinion 448 is disposed on the dial side of the main plate 402 and is configured to be brought in mesh with an hour wheel of the hour wheel 480. A hole portion of the hour wheel 480 is rotatably supported by an outer peripheral portion of a shaft portion of the center pipe 402c.

(2.2) Operation of Second Embodiment:

Next, normal hand operation will be explained in the second embodiment of the timepiece with calendar mechanism according to the invention. In reference to FIG. 24 and FIG. 25, the battery 440 constitutes the power source of the timepiece. The crystal oscillator contained in the quartz unit 650 is oscillated by, for example, 32,768 Hertz. Based on the oscillation of the crystal oscillator, an oscillating portion included in the integrated circuit 654 outputs the reference signal, and the dividing control portion divides the output signal of the oscillating portion. The motor driving portion outputs the motor driving signal for driving the step motor to the coil block 630 based on the output signal of the dividing control portion. When the coil block 630 inputs the motor drive signal, the stator 632 is magnetized to rotate the rotor 634. The rotor 634 is rotated by, for example, 180 degrees per 1 second. Based on rotation of the rotor 634, the fourth wheel & pinion 442 is rotated by way of rotation of the fifth wheel & pinion 441. The fourth wheel & pinion 442 is rotated by one rotation per 1 minute. By the second hand 460 attached to the fourth wheel & pinion 442, “second” of time information is indicated. The third wheel & pinion 444 is rotated based on rotation of the fourth wheel & pinion 442.

The second wheel & pinion 446 is rotated based on rotation of the third wheel & pinion 444. A minute driving wheel & pinion may be used in place of the second wheel & pinion 446. The second wheel & pinion 446 is rotated by one rotation per 1 hour. By the minute hand 462 attached to the second wheel & pinion 446, “minute” of time information is indicated. The slip mechanism is attached to the second wheel & pinion 446. By the slip mechanism, when hands are set, in a state of stopping the second hand 460 by rectifying the wheel portion of the fifth wheel & pinion 442 by the rectifying lever 468, by rotating the hand setting stem 410, the minute hand 462 and the hour hand 464 can be rotated. The minute wheel & pinion 448 is rotated based on rotation of the second wheel & pinion 446. The hour wheel 480 is rotated based on rotation of the minute wheel & pinion 448. The hour wheel 480 is rotated by one rotation per 12 hours. By the hour hand 464 attached to the hour wheel 480, “hour” of time information is indicated.

According to the second embodiment of the timepiece with calendar mechanism of the invention, calendar driving operation, calendar correcting operation or the like is similar to operation of the first embodiment of the timepiece with calendar mechanism according to the invention. That is, by rotating the hour wheel 480, the date driving wheel & pinion 510 is rotated by way of rotation of the intermediate first date driving wheel & pinion 530, the intermediate second date driving wheel & pinion 531, and the date driving finger 511 rotates the program wheel & pinion 540 in the clockwise direction by an amount of one tooth by one time per 1 day. By rotating the program wheel & pinion 540, the first program wheel 544 can rotate the first date indicator 512, the second program wheel 546 can rotate the second date indicator 522, and the third program wheel 548 can rotate the third date wheel 532.

According to the timepiece with calendar mechanism of the invention, the drive mechanism for driving the three date indicators is simple and an area occupied by the drive mechanism is small. Therefore, according to the timepiece with calendar mechanism of the invention, by the compact constitution, recognizability of date indication can simply be promoted. Further, the timepiece with calendar mechanism of the invention is provided with a structure of indicating the position of 1 of date indication by the first date indicator and the second date indicator arranged in two stages and therefore, large date indication can be realized. Further, the timepiece with calendar mechanism of the invention can be configured to make the rotational load of the drive mechanism small. Further, according to the timepiece with calendar mechanism of the invention, a frequency of correcting date at end of month can be made to be 5 times in a year.

By the invention, the timepiece with calendar mechanism in which the drive mechanism for driving the date indicator is simple and an area occupied by the drive mechanism is small can be fabricated. Further, by the invention, the timepiece with calendar mechanism promoting optical recognizability of date indication by a compact constitution can be fabricated. That is, by the invention, in the timepiece with calendar mechanism, large date indication can be realized. Further, according to the timepiece with calendar mechanism of the invention, a load of rotating the drive mechanism is small.

What is claimed is:

1. A timepiece with calendar mechanism for indicating a date by a plurality of date indicators comprising:
a drive mechanism for driving the timepiece with calendar mechanism;
a time indicator for indicating time information by being rotated by operating the drive mechanism;
a first date indicator for indicating one portion of a position of 1 of the date;
a second date indicator for indicating other portion of the position of 1 of the date;
a third date indicator for indicating a position of 10 of the date; and
a program wheel & pinion configured to be able to respectively rotate the first date indicator, the second date indicator, and the third date indicator intermittently based on an operation of the drive mechanism;
wherein information with regard to the date can be indicated by one of first date characters provided at the first date indicator and one of third characters provided at the third date indicator, outer peripheral portions of the first date indicator and the third date indicator being positioned to be proximate to each other, further, information with regard to the date can be indicated by one of second characters provided at the second date indicator and one of the third date characters provided at the third date indicator, outer peripheral portions of the second indicator and the third indicator being positioned to be proximate to each other.

2. A timepiece with calendar mechanism according to claim 1, wherein a rotation center axis line of the first date indicator and a rotation center axis line of the second date indicator are configured to coincide with each other.

3. A timepiece with calendar mechanism according to claim 1, wherein a rotation center axis line of the program wheel & pinion is configured to coincide with a rotation center axis line of the time indicator.

4. A timepiece with calendar mechanism according to claim 1, wherein the program wheel & pinion includes a program date indicator configured to rotate based on the operation of the drive mechanism, a first program wheel configured to be able to rotate integrally with the program date indicator and to be able to intermittently rotate the first date indicator, a second program wheel configured to be able to rotate integrally with the program date indicator and to be able to intermittently rotate the second date indicator, and a third program wheel configured to be able to rotate integrally with the program date indicator and to be able to intermittently rotate the third date indicator.

5. A timepiece with calendar mechanism according to claim 4, wherein the program date indicator includes 31 pieces of teeth portions for receiving the operation of the drive mechanism, the first program wheel includes 18 pieces of teeth portions for rotating the first date wheel, the second program wheel includes 18 pieces of teeth portions for rotating the second date indicator, the third program indicator includes 4 pieces of teeth portions for rotating the third date indicator, the first date indicator includes a first date character indicating face including 5 pieces of numerals aligned in a peripheral direction in an order of “0”, “1”, “2”, “3”, “4”, the second date indicator includes a second date character indicating face including 5 pieces of numerals aligned in a peripheral direction in an order of “5”, “6”, “7”, “8”, “9”, and the third date indicator includes a third date character indicating face including 4 pieces of numerals aligned in a peripheral direction in an order of “0”, “1”, “2”, “3” or 3 pieces of numerals aligned in the peripheral direction in an order of “1”, “2”, “3”.

6. A timepiece with calendar mechanism according to claim 4, further comprising an intermediate date driving wheel configured to rotate based on the operation of the drive mechanism and arranged to overlap the program wheel & pinion, a date driving wheel configured to rotate based on rotation of the intermediate date driving wheel, and a date driving finger configured to rotate based on rotation of the date driving wheel, wherein the program date wheel is configured to rotate based on rotation of the date driving finger.

7. A timepiece with calendar mechanism according to claim 1, further comprising a program date indicator jumper for rectifying rotation of the program date indicator, a first date indicator jumper for rectifying rotation of the first date indicator, a second date indicator jumper for rectifying rotation of the second date indicator, and a third date indicator jumper for rectifying rotation of the third date indicator.

8. A timepiece with calendar mechanism according to claim 1, further comprising a calendar correcting mechanism capable of correcting a display content of the first date indicator, a display content of the second date indicator, a display content of the third date indicator by rotating a hand setting stem in a state of pulling the hand setting stem to a hand setting stem position capable of correcting a calendar, wherein the calendar correcting mechanism includes a calendar correcting wheel, and is configured to be able to rotate the program wheel & pinion by rotating the calendar correcting wheel based on rotation of the hand setting stem in a state of pulling the hand setting stem to the hand setting stem position capable of correcting the calendar.
